(19) United States
(12) Patent Application Publication
(10) Pub. No.: US 2024/0428584 A1
(43) Pub. Date: Dec. 26, 2024

(54) METHOD FOR DIURNAL VARIATION CALIBRATION FOR PLANT PHENOTYPING

(71) Applicant: Purdue Research Foundation, West Lafayette, IN (US)

(72) Inventors: Jian Jin, West Lafayette, IN (US); Jinnuo Zhang, West Lafayette, IN (US)

(73) Assignee: Purdue Research Foundation, West Lafayette, IN (US)

(21) Appl. No.: 18/748,010

(22) Filed: Jun. 19, 2024

Related U.S. Application Data
(60) Provisional application No. 63/522,050, filed on Jun. 20, 2023.

(51) Int. Cl. G06V 20/10; G06T 5/50; G06T 11/20; G06V 10/62

(52) U.S. Cl. CPC G06V 20/188; G06T 5/50; G06T 11/206; G06V 10/62; G06T 2207/10036

(57) ABSTRACT

A method of calibrating hyperspectral images to account for diurnal changes is disclosed which includes receiving a plurality of hyperspectral images obtained over a plurality of days from a field, deriving a plurality of spectra from the received plurality of hyperspectral images, decomposing the derived plurality of spectra into a trend component representing a trend associated with the plurality of days, subtracting the trend component from the derived plurality of spectra to thereby generate diurnal spectra for one or more wavelengths, fitting one or more mathematical functions associating spectrum to time of day to the generated diurnal spectra for each of the one or more wavelengths, generating a mode from the fitted mathematical function for each of the one or more wavelengths, and applying the model to the derived spectra at a first time to generate a calibrated spectra at a second time.

### CROSS-REFERENCE TO RELATED APPLICATIONS

The present non-provisional patent application is related to and claims the priority benefit of U.S. Provisional Patent Application Ser. 63/522,050, filed Jun. 20, 2023, the contents of which are hereby incorporated by reference in its entirety into the present disclosure.

### STATEMENT REGARDING GOVERNMENT FUNDING

None.

### TECHNICAL FIELD

The present disclosure generally relates to plant phenotyping and in particular to a method for image calibration accounting for diurnal variation.

### BACKGROUND

This section introduces aspects that may help facilitate a better understanding of the disclosure. Accordingly, these statements are to be read in this light and are not to be understood as admissions about what is or is not prior art.

Phenotyping generally relates to a process of measuring characteristics of plants to analyze parameters such as stress, herbicide tolerance, yield, crop health, nutrient status, soil moisture, and other important traits that can impact crop growth and development. Nowadays, remote sensing, combined with spectral imaging technology, is becoming an increasingly important and promising tool in crop and agricultural management. It allows for the efficient gathering of critical information that can help optimize crop yield, maximize farmers' profit, and accelerate the progress of plant breeding. Specifically, unmanned aerial vehicle (UAV)-based remote sensing is particularly effective in monitoring above-referenced parameters. Since phenotyping is a data-driven technology, the quality of obtained data in remote sensing plays an essential role in outputting the final decision. However, both atmospheric effects and instrumental noises can degrade the received hyperspectral image quality as well as diurnal variation of the plant.

Specifically, diurnal spectral variation caused by variation in the solar radiation and atmospheric condition also introduces substantial signal variance in spectra. Several active and passive regulations, including photosynthesis, transpiration, and stomatal conductance, could be related to the plants' diurnal spectral response. Therefore, the spectral reflectance of the same plant has different properties over the course of a day. Without alleviating the diurnal pattern effect, it is challenging to determine whether the variance in the collected spectrum can be attributed to a major treatment difference or simply to the diurnal variance. To prevent this issue, UAV-based spectral image collection is typically scheduled during the sunny daytime to ensure sufficient sunlight for high-quality images. However, it might be difficult to completely avoid the influence of diurnal spectral changes, especially if the entire image capture process takes several hours.

Therefore, there is an unmet need for a novel method that can effectively calibrate the diurnal variability in order to ensure accurate and reliable measurements.

### SUMMARY

A method of calibrating hyperspectral images from a field of one or more plants to account for diurnal changes at different times is disclosed. The method includes receiving a plurality of hyperspectral images over a plurality of days from a field having planted thereon one or more plants, deriving a plurality of spectra from the received plurality of hyperspectral images, decomposing the derived plurality of spectra into a trend component representing a trend associated with the plurality of days, subtracting the trend component from the derived plurality of spectra to thereby generate diurnal spectra for one or more wavelengths, fitting one or more mathematical functions associating spectrum to time of day to the generated diurnal spectra for each of the one or more wavelengths, generating a model from the fitted mathematical function for each of the one or more wavelengths, and applying the model to the obtained spectra at a first time to generate a calibrated spectra at a second time.

Another method of generating a model based on received hyperspectral images from a field of one or more plants to account for diurnal changes at different times is disclosed. The method includes receiving a plurality of hyperspectral images over a plurality of days from a field having planted thereon one or more plants, deriving a plurality of spectra from the received plurality of hyperspectral images, decomposing the derived plurality of spectra into a trend component representing a trend associated with the plurality of days, subtracting the trend component from the derived plurality of spectra to thereby generate diurnal spectra for one or more wavelengths, fitting one or more mathematical functions associating spectrum to time of day to the generated diurnal spectra for each of the one or more wavelengths, and generating a model from the fitted mathematical functions for each of the one or more wavelengths.

Yet another method of applying a model based on received hyperspectral images from a field of one or more plants to account for diurnal changes at different times is disclosed. The method includes establishing a plurality of spectra based on a plurality of captured hyperspectral images over a plurality of days from a field having planted thereon one or more plants, receiving a model associating spectrum to time of day for one or more wavelengths, wherein the received model takes into account diurnal changes at different times, and applying the model to the established plurality of spectra at a first time to generate a calibrated spectra at a second time.

### BRIEF DESCRIPTION OF FIGURES

FIG. 1 is a flowchart that depicts the processing steps of the method of the present disclosure.

FIGS. 2A and 2B provide comparison curves which result from an original Normalized Difference Vegetation Index (NDVI) value at different days after plantation (DAP) and the NDVI value after trend and seasonal decomposition based on locally weighted scatterplot smoothing (LOESS), according to the present disclosure.

FIG. 2C is an example of modification from an original spectrum to identification of trend and de-trending, i.e., diurnal representation is shown for one single wavelength, according to the methods of the present disclosure.

FIGS. 3A, 3B, 3C, 3D, 3E, 3F, 3G, 3H, and 3I are nine reflectance vs. time calibration curves of corresponding spectral bands, which are shown as distributed throughout the entire spectral range providing reflectance (spectrum) vs. time of day each for a different wavelength.

FIGS. 4A and 4B provide both two-dimensional and three-dimensional visualizations to illustrate the variation surfaces with respect to daily time and wavelength, where FIG. 4A is a 2D heatmap, and FIG. 4B is the 3D surface maps at both 45° and 325° view angles.

FIG. 5 illustrates training and testing results of diurnal calibration models utilizing a polynomial with a degree of four thereby providing the regression performance of the established diurnal calibration model in the VNIR spectral range, according to the method of the present disclosure.

FIGS. 6A, 6B, 6C, and 6D are graphs of reflectance vs. wavelength for averaged spectra under full nitrogen and low nitrogen treatment from two corn genotypes' testing sets, where FIGS. 6A and 6C provide the original spectra; and FIGS. 6B and 6D provide the spectra after diurnal calibration to solar noon.

FIGS. 7A and 7B provide a variance reduction ratio at different wavelengths after diurnal calibration, where FIG. 7A is a bar graph of variance reduction (%) vs. wavelength (nm) which provides the variance reduction ratio at all available wavelengths; and FIG. 7B which provides graphs of reflectance before and after calibration for a number of different wavelengths.

### DETAILED DESCRIPTION

For the purposes of promoting an understanding of the principles in the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 10%, within 5%, or within 1% of a stated value or of a stated limit of a range.

In the present disclosure, the term “substantially” can allow for a degree of variability in a value or range, for example, within 90%, within 95%, or within 99% of a stated value or of a stated limit of a range.

A novel method is disclosed herein that can effectively calibrate the diurnal variability in order to ensure accurate and reliable phenotyping measurements. Modeling diurnal spectral patterns at different times of day has the great potential to provide guidelines for remote sensing spectral data quality improvement. Towards this end, the method of the present disclosure provides a spectral range for diurnal pattern calibration to all the available wavelengths. The hyperspectral images of plant canopy were obtained in consecutive measurements with a short time interval at the different growth stages. The method of the present disclosure then first explores the diurnal spectral variation patterns of different wavelengths in the range of visible and near-infrared; and builds calibration models for all relevant wavelengths to alleviate diurnal spectral variation at a certain time. The effectiveness of calibration models is then verified through variance comparison.

A field experiment was carried out on two genotypes of corn: P1105AM and B73×Mo17. The corn plants of different genotypes were cultivated parallel to each other alongside a gantry imaging tower. A protection crop row was sown closest to the gantry to minimize any additional environmental impact on the experimental plots. Each small plot was of size 3 m and had 15 corn plants. A sample of 12 small plots was selected. At the V4 stage, two fertilization treatments were applied to specific corn plots using nitrogen solutions with different concentrations, respectively.

The corn canopy remote reflectance measurements were carried out using a visible and near-infrared (VNIR) hyperspectral sensor (MSV-101-W, Middleton Spectral Vision, Middleton, WI, USA) mounted on a gantry platform. The sensor was positioned 7 m above the ground, and its field of view covered a strip of land measuring 250 square meters. Using the gantry imaging system within a spectral resolution of 1.22 nm, the hyperspectral images of the corn canopy were captured every 2.5 min within the spectral range of 376 nm-1044 nm. This setup provided the capability for high-frequency time-series monitoring of diurnal spectral changes. Hyperspectral images were acquired for 33 consecutive days after implementing the nutrient treatments. Each day, the gantry imaging system moved backward and forward from 8 am to 7 pm in order to capture the targeted corn canopy reflectance. In total, 8712 hyperspectral images were collected and formed the sample dataset for further processing and modeling.

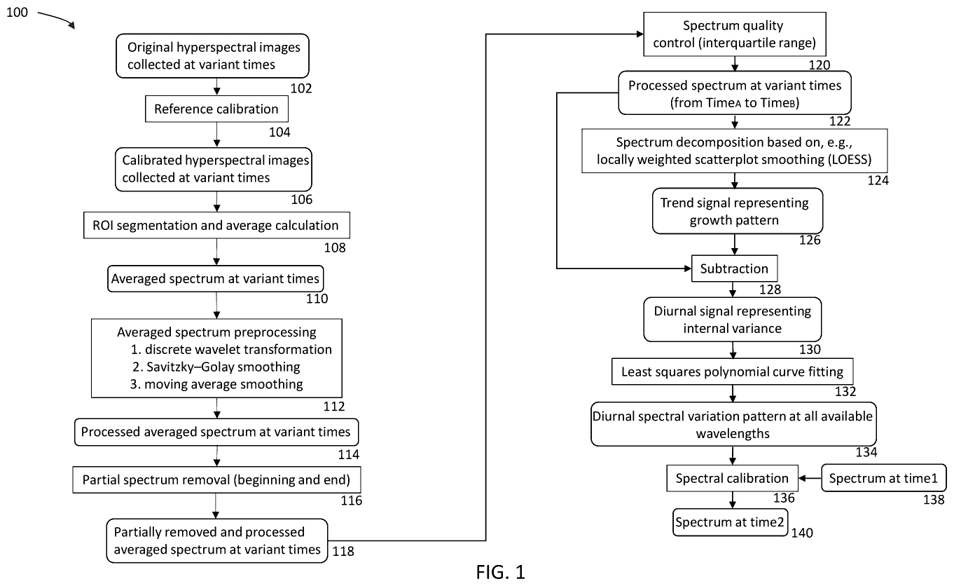

Referring to FIG. 1, a flowchart 100 is provided that depicts the processing steps of the method of the present disclosure. As provided in FIG. 1, a set of hyperspectral images are obtained at varying times from a field. These images are denoted as original hyperspectral images collected at variant times in FIG. 1, as indicated by block 102. To account for variations in illumination conditions and atmospheric effects that could impact the spectral signatures of targets in the scene, a reflectance calibration Formula (1) was applied to all hyperspectral images as the first pre-processing step to correct for ambient light influence. A reference plate attached to the sensors was used to obtain white reference data, while the reflectance of a black board served as a dark reference during the reflectance calibration process.

$$R = \frac{{R}_{raw} - {R}_{dark}}{{R}_{white} - {R}_{dark}} , \qquad ( 1 )$$

where the R_{raw}, R_{dark}, and R_{white} represent the reflectance of the raw image, dark reference, and white reference, respectively. This calibration process is denoted as reference calibration in FIG. 1, as indicated by block 104. The output of this calibration is denoted as calibrated hyperspectral images collected at variant times, as indicated by block 106.

Next, the calibrated hyperspectral images collected at variant times are segmented and undergo an averaging function. Specifically, a region of interest (ROI) segmentation algorithm, which is based on the distinction between the background field and foreground plants, can be employed to extract the average canopy spectra of each individual plant plot. To improve the accuracy of segmentation results, a classic spectral index Normalized Difference Vegetation Index (NDVI) was selected to calculate the heatmap for threshold segmentation, however, other methods known to a person having ordinary skill in the art are also within the scope of the present disclosure. This segmentation procedure is identified in FIG. 1 as ROI segmentation and average calculation, as indicated by block 108. It should be noted that prior to this block, the calibrated hyperspectral images contain both the plants and other backgrounds. However, only the spectral information of the plants are of interest. Thus, the NDVI value are used as a threshold to segment the plant region in the hyperspectral images. Once we obtain the locations of the plant regions, we can calculate the average spectrum of the entire plant region, as indicated by block 110.

After collecting the average spectra from multiple time points and plots, various spectral data preprocessing techniques were employed to eliminate noise and improve the signal-to-noise ratio, including discrete wavelet transformation, Savitzky-Golay smoothing and moving average smoothing, however, other techniques known to a person having ordinary skill in the art may be applied. This block is denoted as averaged spectrum preprocessing, as indicated by block 112. The discrete wavelet transformation is a powerful tool that allows the resolution of spectral features into multilevel components, representing both high- and low-frequency information. A wavelet named ‘db9’ was utilized with a decomposition level of 5 and a threshold equivalent to 80% of its relative maximum value to suppress high-frequency noise signals. It should be appreciated that other techniques may be utilized to serve this function. Then, the Savitzky-Golay smoothing, which used a two-degree polynomial function to estimate the central point values of a given window size of 20, although other window sizes are within the scope of the present disclosure, was applied. The algorithm eliminated outliers by fitting a curve that followed the overall trend of the spectral data, while still preserving the underlying patterns and characteristics of the data. It should be appreciated that other techniques may be utilized to serve this function. Additionally, the moving average smoothing, which combined the values in the window size of 5, although other window sizes are within the scope of the present disclosure, made sure that high frequency noise was removed. It should be appreciated that other techniques may be utilized to serve this function. The output of the averaged spectrum preprocessing is denoted as processed averaged spectrum at variant times, as indicated by block 114.

Next, several wavelengths from the beginning and end of the spectra were also removed to mitigate the impact of noise and spectra artifacts brought about by the instrumentation, leaving a total of 540 wavelengths to be preprocessed. This removal process is denoted as partial spectrum removal (beginning and end) in FIG. 1, as indicated by block 116, resulting in an output denoted as partially removed and processed averaged spectrum at variant times, as indicated by block 118.

Next, the available spectral data underwent a data quality check based on the interquartile range from a single wavelength, as indicated by block 120, to generate processed spectrum at variant times from time_{A} to time_{B}, as indicated by block 122.

The quality control of the spectra based on the interquartile range removes the outlier data points from the scatter plots, in other words only the data within the interquartile range is kept to generate the processed spectrum. Ultimately, the time interval selected for diurnal analysis was from 10 a.m. to 5 p.m. Eastern Daylight Time, although other time ranges can be chosen, in order to simulate the typical working hours of the practical UAV flights. Together, these hyperspectral image pre-processing procedures helped to refine the spectral data and improve their quality for further analysis.

During the almost month-long experiment of collecting the hyperspectral information of the plant canopy, the natural growth of the plants may have contributed to the inherent variance observed in the spectra. To reveal a clearer diurnal pattern for each individual day, it was necessary to eliminate the influence of daily growth. Therefore, a non-parametric regression method known as locally weighted scatterplot smoothing (LOESS) was selected, as indicated by block 124, to decompose the seasonal and trend signals from all the wavelength scatterplots. The VNIR reflectance from various growth stages and genotypes leads to trend signal representing the growth pattern, as indicated by block 126. To alleviate the growth stage variance, the trend signal was subtracted from the original spectral reflectance pattern after a signal normalization, as indicated by block 128. This operation is because the trend signal only represents the growth effect of plants. Therefore, the diurnal variant without the influence of the trend signal is of interest. In other words, seasonal signal is equal to original spectral reflectance minus the trend signal, as indicated by the resulting block 130.

The daily time interval was selected as the primary factor for establishing connections with the diurnal reflectance variations across various wavelengths. The format of the recording time was converted into decimals for the later establishment of a calibration model. Reflectance values at the same wavelength from different dates were integrated and split into a training set and a testing set at a ratio of 7:3. In each dataset, the reflectance values were averaged based on the daily time data in order to combine multiple outputs. The least squares polynomial curve fitting algorithm, which had a rapid inference ability, was utilized to construct the diurnal calibration models for the 540 wavelengths at different daily time intervals. This algorithm was able to find the coefficients of the polynomial to fit the diurnal pattern by minimizing the sum of the squares of the differences between the reflectance points and the polynomial curve, as indicated by block 132. To prevent severe overfitting, the degree of the fitting polynomial was set to 4 using 10-fold cross-validation. The curve function formula (Formula (2)) and the relative loss formula (Formula (3)) are provided as follows:

$$y = {a}_{0} + {a}_{1} x + {a}_{2} {x}^{2} + … + {a}_{k} {x}^{k} \qquad ( 2 )$$

$$L = {{\sum }_{i = 1}^{n} [ {Y}_{i} - ( {a}_{0} + {a}_{1} x + {a}_{2} {x}^{2} + … + {a}_{k} {x}^{k} ) ]}^{2} \qquad ( 3 )$$

where x represents the daily time and y and Yᵢ denote the output reflectance of least squares polynomial curve and the ground truth reflectance, respectively. aₖ represents the coefficient at the k^{th} polynomial. The output of the least squares polynomial curve fitting block is the Diurnal spectral variation pattern at all available wavelengths.

On the basis of the learned polynomial coefficient, the diurnal spectral variation pattern at all relevant wavelengths, shown as block 134, served as a reference table for later calibration. The ratio matrix of reflectance, derived from two arbitrary time points, represented the relationship between reflectance values and the varying time. Formula (4) illustrated the specific process of this transformation:

$${R}_{t} = [ \frac{{dR}_{t 1}}{{dR}_{r 1}} , \frac{{dR}_{t 2}}{{dR}_{r 2}} , \frac{{dR}_{t 3}}{{dR}_{r 3}} , ... , \frac{{dR}_{tn}}{{dR}_{rn}} ] ⊙ {R}_{r} \qquad ( 4 )$$

where the dRₜₙ represents the reflectance derived from the diurnal curve at the nth wavelength and the target time point. dRᵣₙ indicates the reflectance derived from the diurnal curve at the nth wavelength and the reference time point. Rᵣ and Rₜ denote the actual reflectance derived from the reference time point and target time point. The circle with a dot represents element-wise multiplication. With the diurnal spectral variation pattern at all available wavelengths known, a spectrum at time 1 can be corrected to a spectrum at time 2 as provided in FIG. 1, based on the spectral calibration block 136 and spectrum at time₁ to achieve spectrum at time₂, as indicated by blocks 138 and 140, respectively.

To assess the performance of the established polynomial models fitted to various diurnal patterns at different wavelengths, the coefficient of determination (R²), which provided the values of the explained diurnal variance and root mean square error (RMSE), was selected as the evaluation metric. Additionally, the standard deviation for each wavelength at varying time points was computed to partially represent the impact of diurnal fluctuations. This analysis offered further insight into the variability of the data and helped to better understand the extent of diurnal influence on each wavelength. The hyperspectral imaging processing algorithms were executed on a Windows 10 operating system powered by an AMD Ryzen 7 5800H CPU. To build and evaluate the diurnal models, open-source Python 3.10.8 (https://www.python.org/, accessed on 6 Jan. 2023) was employed in conjunction with OpenCV and various other public libraries (NumPy, Pandas and so on). This software stack enabled the effective analysis and modeling of the diurnal patterns in the data.

$${R}^{2} = 1 - \frac{{\sum }_{i = 1}^{i = m} {( {y}_{i} - {\hat{y}}_{ι} )}^{2}}{{\sum }_{i = 1}^{i = m} {( {y}_{i} - \overline{y} )}^{2}} \qquad ( 5 )$$

$$RMSE = \sqrt{\frac{1}{m} {\sum }_{i = 1}^{m} {( {y}_{i} - {\hat{y}}_{ι} )}^{2}} \qquad ( 6 )$$

where yᵢ and ŷ_{ι} represent the true value and predicted value of sample i, respectively. The y̅ denotes the averaged value of all samples (i=1, 2, 3, 4, . . . , m).

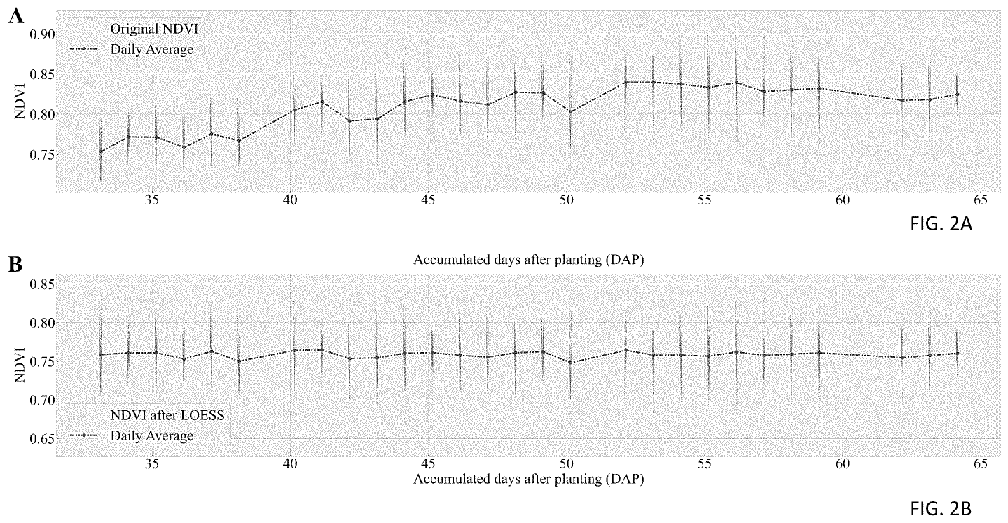

NDVI is a valuable tool for assessing vegetation health and vigor. Thus NDVI was used to compare the difference before and after applying the LOESS subtraction to show the effectiveness of trend elimination. Comparison curves which result from the original NDVI value at different days after plantation (DAP) and the NDVI value after trend and seasonal decomposition based on LOESS are shown in FIGS. 2A and 2B. An example calculation of NDVI is:

$$NDVI = \frac{{R}_{800} - {R}_{650}}{{R}_{800} + {R}_{650}} \qquad ( 7 )$$

Where R₈₀₀ and R₆₅₀ represent the reflectance at 800 nm and 650 nm. The original NDVI value had relative severe fluctuation with the changing of time as shown in FIG. 2A and the NDVI value after LOESS kept a relative stable fluctuation at different DAP) as shown in FIG. 2B. Referring to FIG. 2C, an example of modification from original spectrum to identification of trend and de-trending, i.e., diurnal representation is shown for one single wavelength. In other words, the original averaged spectrum signal consists of day-to-day trend component and the diurnal pattern. FIG. 2C shows one spectra example of the decomposition results at 854 nm wavelength. This change suggests that the detrending process effectively removed the growth stage variance while still maintaining the overall spectral patterns and relationships between different time points. The detrending algorithm allowed for a clearer diurnal pattern to be revealed for each individual day, facilitating a more accurate analysis of the spectral data.

Diurnal calibration model and its parameters are now discussed in greater detail. The polynomial shown in formula (2) is repeated below:

$${R}_{n} = {a}_{0} + {a}_{1} x + {a}_{2} {x}^{2} + {a}_{3} {x}^{3} + {a}_{4} {x}^{4} \qquad ( 8 )$$

where recording time xᵣ and the targeting time xₜ are first converted into decimals. Then, xᵣ and xₜ will be respectively sent into formula (8) to obtain the relative reflectance Rᵣₙ and Rₜₙ at the n wavelength, resulting in formulas (9) and (10).

$${R}_{tn} = {a}_{0} + {a}_{1} {x}_{t} + {a}_{2} {{x}_{t}}^{2} + {a}_{3} {{x}_{t}}^{3} + {a}_{4} {{x}_{t}}^{4} \qquad ( 9 )$$

$${R}_{rn} = {a}_{0} + {a}_{1} {x}_{r} + {a}_{2} {{x}_{r}}^{2} + {a}_{3} {{x}_{r}}^{3} + {a}_{4} {{x}_{r}}^{4} \qquad ( 10 )$$

The corresponding coefficients matrix is shown in Table 1.

TABLE 1
The coefficients matrix for the diurnal calibration model
at variant wavelengths for a 4^{th} order polynomial

| Wave- | | | | | |
|---|---|---|---|---|---|
| length(nm) | a₀ | a₁ | a₂ | a₃ | a₄ |
| 397 | 2.45E−05 | −0.00133 | 0.027829 | −0.26436 | 0.997948 |
| 398 | 2.31E−05 | −0.00126 | 0.026245 | −0.24964 | 0.945254 |
| 399 | 2.4E−05 | −0.0013 | 0.027224 | −0.25791 | 0.969274 |
| 400 | 2.44E−05 | −0.00132 | 0.027501 | −0.25935 | 0.96882 |
| 402 | 2.32E−05 | −0.00126 | 0.026313 | −0.2487 | 0.931593 |
| 403 | 2.46E−05 | −0.00134 | 0.027851 | −0.26204 | 0.97289 |
| 404 | 2.49E−05 | −0.00136 | 0.02824 | −0.26512 | 0.980103 |
| 405 | 2.67E−05 | −0.00145 | 0.030055 | −0.28035 | 1.025666 |
| 406 | 2.65E−05 | −0.00144 | 0.029918 | −0.27886 | 1.018527 |
| 407 | 2.71E−05 | −0.00147 | 0.030442 | −0.28265 | 1.026777 |
| 408 | 2.83E−05 | −0.00154 | 0.031844 | −0.29533 | 1.068279 |
| 409 | 3.05E−05 | −0.00166 | 0.034338 | −0.31718 | 1.138164 |
| 410 | 3.13E−05 | −0.00171 | 0.03529 | −0.32552 | 1.16418 |
| 411 | 3.32E−05 | −0.00181 | 0.037352 | −0.34334 | 1.22027 |
| 412 | 3.57E−05 | −0.00195 | 0.040099 | −0.36745 | 1.297833 |
| 414 | 3.56E−05 | −0.00195 | 0.040048 | −0.36695 | 1.294945 |
| 415 | 3.9E−05 | −0.00213 | 0.043748 | −0.39905 | 1.397553 |
| 416 | 4.1E−05 | −0.00224 | 0.045884 | −0.41749 | 1.455694 |
| 417 | 4.27E−05 | −0.00233 | 0.047807 | −0.43412 | 1.508222 |
| 418 | 4.4E−05 | −0.0024 | 0.049175 | −0.44585 | 1.544596 |
| 419 | 4.35E−05 | −0.00238 | 0.048625 | −0.44006 | 1.521579 |
| 420 | 4.46E−05 | −0.00244 | 0.049733 | −0.44894 | 1.546931 |
| 421 | 4.54E−05 | −0.00249 | 0.050842 | −0.45941 | 1.582421 |
| 422 | 4.89E−05 | −0.00268 | 0.054718 | −0.49296 | 1.689291 |
| 423 | 4.74E−05 | −0.0026 | 0.053049 | −0.47751 | 1.635519 |
| 424 | 4.85E−05 | −0.00266 | 0.054354 | −0.48899 | 1.672015 |
| 426 | 5.07E−05 | −0.00278 | 0.056638 | −0.50829 | 1.731916 |
| 427 | 5.13E−05 | −0.00281 | 0.057286 | −0.51309 | 1.744049 |
| 428 | 5.12E−05 | −0.0028 | 0.057041 | −0.51002 | 1.730397 |
| 429 | 5.13E−05 | −0.00281 | 0.057125 | −0.51015 | 1.72824 |
| 430 | 4.95E−05 | −0.00271 | 0.055267 | −0.49361 | 1.67301 |
| 431 | 5.13E−05 | −0.00281 | 0.05725 | −0.51051 | 1.725979 |
| 432 | 5.24E−05 | −0.00287 | 0.058451 | −0.52084 | 1.758518 |
| 433 | 5.21E−05 | −0.00286 | 0.058131 | −0.51761 | 1.746045 |
| 434 | 5.34E−05 | −0.00293 | 0.059571 | −0.52996 | 1.785377 |
| 435 | 5.27E−05 | −0.00289 | 0.058862 | −0.52364 | 1.764148 |
| 436 | 5.32E−05 | −0.00292 | 0.059311 | −0.52662 | 1.770224 |
| 438 | 5.28E−05 | −0.0029 | 0.058895 | −0.52258 | 1.755586 |
| 439 | 5.38E−05 | −0.00296 | 0.060049 | −0.53271 | 1.788256 |
| 440 | 5.63E−05 | −0.00309 | 0.062756 | −0.55643 | 1.865146 |
| 441 | 5.72E−05 | −0.00314 | 0.063682 | −0.56382 | 1.886246 |
| 442 | 5.85E−05 | −0.00321 | 0.065004 | −0.57474 | 1.91905 |
| 443 | 5.84E−05 | −0.00321 | 0.064977 | −0.57422 | 1.915615 |
| 444 | 5.73E−05 | −0.00315 | 0.063782 | −0.56326 | 1.877276 |
| 445 | 5.76E−05 | −0.00317 | 0.064111 | −0.56571 | 1.882774 |
| 446 | 5.79E−05 | −0.00318 | 0.064532 | −0.56954 | 1.894333 |
| 447 | 5.78E−05 | −0.00318 | 0.064396 | −0.56784 | 1.885801 |
| 448 | 5.92E−05 | −0.00325 | 0.065842 | −0.57975 | 1.920619 |
| 450 | 5.94E−05 | −0.00326 | 0.066046 | −0.58094 | 1.921159 |
| 451 | 5.93E−05 | −0.00325 | 0.065705 | −0.57646 | 1.900235 |
| 452 | 5.97E−05 | −0.00327 | 0.065891 | −0.57652 | 1.893752 |
| 453 | 6.2E−05 | −0.00339 | 0.068281 | −0.59642 | 1.953449 |
| 454 | 6.33E−05 | −0.00347 | 0.069667 | −0.60778 | 1.986287 |
| 455 | 6.29E−05 | −0.00344 | 0.069085 | −0.60167 | 1.961644 |
| 456 | 6.37E−05 | −0.00348 | 0.069812 | −0.60715 | 1.975047 |
| 457 | 6.36E−05 | −0.00348 | 0.06973 | −0.60569 | 1.966397 |
| 458 | 6.34E−05 | −0.00347 | 0.069435 | −0.60243 | 1.952025 |
| 459 | 6.34E−05 | −0.00347 | 0.069433 | −0.60196 | 1.947413 |
| 461 | 6.31E−05 | −0.00344 | 0.06894 | −0.59675 | 1.926108 |
| 462 | 6.18E−05 | −0.00338 | 0.06764 | −0.58489 | 1.884352 |
| 463 | 6.16E−05 | −0.00336 | 0.067165 | −0.57923 | 1.859707 |
| 464 | 6.21E−05 | −0.00339 | 0.067673 | −0.58338 | 1.871034 |
| 465 | 6.23E−05 | −0.0034 | 0.067879 | −0.58487 | 1.87407 |
| 466 | 6.08E−05 | −0.00332 | 0.066148 | −0.56899 | 1.819445 |
| 467 | 6.07E−05 | −0.00331 | 0.065986 | −0.56701 | 1.810626 |
| 468 | 6.05E−05 | −0.0033 | 0.065726 | −0.56398 | 1.797866 |
| 469 | 5.86E−05 | −0.00319 | 0.063544 | −0.54402 | 1.729973 |
| 470 | 5.76E−05 | −0.00314 | 0.062306 | −0.53259 | 1.690713 |
| 472 | 5.76E−05 | −0.00314 | 0.062324 | −0.53267 | 1.690844 |
| 473 | 5.71E−05 | −0.00311 | 0.061649 | −0.52592 | 1.666431 |
| 474 | 5.78E−05 | −0.00314 | 0.062282 | −0.53093 | 1.681403 |
| 475 | 5.69E−05 | −0.00309 | 0.061331 | −0.52233 | 1.652929 |
| 476 | 5.7E−05 | −0.0031 | 0.061416 | −0.52289 | 1.654728 |
| 477 | 5.71E−05 | −0.0031 | 0.061392 | −0.52209 | 1.650604 |
| 478 | 5.71E−05 | −0.0031 | 0.061344 | −0.52162 | 1.649645 |
| 479 | 5.53E−05 | −0.003 | 0.059352 | −0.50386 | 1.591814 |
| 480 | 5.51E−05 | −0.00299 | 0.059153 | −0.50202 | 1.586399 |
| 481 | 5.46E−05 | −0.00296 | 0.05857 | −0.49697 | 1.571036 |
| 483 | 5.43E−05 | −0.00295 | 0.058254 | −0.49424 | 1.563174 |
| 484 | 5.47E−05 | −0.00297 | 0.058717 | −0.49838 | 1.577765 |
| 485 | 5.38E−05 | −0.00292 | 0.057619 | −0.48809 | 1.543023 |
| 486 | 5.25E−05 | −0.00285 | 0.056246 | −0.47591 | 1.503722 |
| 487 | 5.01E−05 | −0.00272 | 0.053749 | −0.45433 | 1.435348 |
| 488 | 5.1E−05 | −0.00277 | 0.054662 | −0.46197 | 1.45983 |
| 489 | 5.03E−05 | −0.00273 | 0.05389 | −0.45494 | 1.436862 |
| 490 | 5.24E−05 | −0.00284 | 0.056118 | −0.47423 | 1.49946 |
| 491 | 5.03E−05 | −0.00272 | 0.053684 | −0.45237 | 1.427467 |
| 493 | 5.05E−05 | −0.00273 | 0.053758 | −0.45224 | 1.425238 |
| 494 | 5.08E−05 | −0.00275 | 0.054091 | −0.4549 | 1.43372 |
| 495 | 4.87E−05 | −0.00263 | 0.051762 | −0.43423 | 1.366518 |
| 496 | 4.65E−05 | −0.00252 | 0.049416 | −0.4137 | 1.300765 |
| 497 | 4.42E−05 | −0.0024 | 0.046996 | −0.39209 | 1.229835 |
| 498 | 4.27E−05 | −0.00232 | 0.045383 | −0.37786 | 1.183994 |
| 499 | 4.2E−05 | −0.00228 | 0.044779 | −0.37283 | 1.16916 |
| 500 | 4.16E−05 | −0.00226 | 0.044317 | −0.36848 | 1.154816 |
| 501 | 4.13E−05 | −0.00224 | 0.04398 | −0.36542 | 1.145357 |
| 503 | 4.22E−05 | −0.0023 | 0.045067 | −0.37507 | 1.177871 |
| 504 | 4.24E−05 | −0.00231 | 0.045224 | −0.37604 | 1.180891 |
| 505 | 4.37E−05 | −0.00237 | 0.046513 | −0.38659 | 1.213576 |
| 506 | 4.23E−05 | −0.0023 | 0.045062 | −0.37376 | 1.171908 |
| 507 | 4.14E−05 | −0.00225 | 0.044014 | −0.36403 | 1.139385 |
| 508 | 4.12E−05 | −0.00223 | 0.043595 | −0.35912 | 1.120361 |
| 509 | 3.78E−05 | −0.00205 | 0.039866 | −0.3254 | 1.008156 |
| 510 | 3.79E−05 | −0.00205 | 0.039922 | −0.32548 | 1.007994 |
| 511 | 3.63E−05 | −0.00197 | 0.038342 | −0.31176 | 0.964546 |
| 512 | 3.75E−05 | −0.00204 | 0.03976 | −0.32439 | 1.007371 |
| 514 | 3.8E−05 | −0.00207 | 0.040333 | −0.329 | 1.022127 |
| 515 | 3.76E−05 | −0.00205 | 0.040044 | −0.32659 | 1.01573 |
| 516 | 3.97E−05 | −0.00216 | 0.042039 | −0.34262 | 1.064254 |
| 517 | 4.25E−05 | −0.00231 | 0.044987 | −0.36783 | 1.145496 |
| 518 | 4.11E−05 | −0.00223 | 0.043388 | −0.35307 | 1.096394 |
| 519 | 3.73E−05 | −0.00202 | 0.039091 | −0.31392 | 0.965462 |
| 520 | 3.8E−05 | −0.00207 | 0.039987 | −0.32175 | 0.992134 |
| 521 | 3.86E−05 | −0.0021 | 0.040694 | −0.32794 | 1.013804 |
| 522 | 3.99E−05 | −0.00217 | 0.041981 | −0.33819 | 1.0452 |
| 524 | 4.04E−05 | −0.0022 | 0.042557 | −0.34315 | 1.062507 |
| 525 | 4.06E−05 | −0.00221 | 0.042792 | −0.34477 | 1.067866 |
| 526 | 4.11E−05 | −0.00224 | 0.04345 | −0.35058 | 1.088195 |
| 527 | 3.97E−05 | −0.00217 | 0.042262 | −0.34108 | 1.061956 |
| 528 | 3.96E−05 | −0.00217 | 0.042225 | −0.34088 | 1.063459 |
| 529 | 4.02E−05 | −0.0022 | 0.042778 | −0.34516 | 1.077246 |
| 530 | 3.96E−05 | −0.00218 | 0.042382 | −0.34204 | 1.06999 |
| 531 | 4.28E−05 | −0.00235 | 0.045902 | −0.37318 | 1.17367 |
| 533 | 4.56E−05 | −0.0025 | 0.049019 | −0.40098 | 1.267242 |
| 534 | 4.71E−05 | −0.00259 | 0.050792 | −0.41694 | 1.322132 |
| 535 | 4.78E−05 | −0.00263 | 0.051715 | −0.4254 | 1.352251 |
| 536 | 4.85E−05 | −0.00267 | 0.052479 | −0.43197 | 1.374657 |
| 537 | 4.91E−05 | −0.00271 | 0.053291 | −0.43946 | 1.401563 |
| 538 | 5.02E−05 | −0.00277 | 0.054533 | −0.45083 | 1.441395 |
| 539 | 5.07E−05 | −0.0028 | 0.055236 | −0.45762 | 1.466863 |
| 540 | 5.48E−05 | −0.00302 | 0.05971 | −0.49701 | 1.59684 |
| 541 | 5.51E−05 | −0.00304 | 0.060264 | −0.50299 | 1.621077 |
| 543 | 5.84E−05 | −0.00322 | 0.06394 | −0.5356 | 1.729145 |
| 544 | 5.9E−05 | −0.00326 | 0.06468 | −0.54269 | 1.755083 |
| 545 | 5.97E−05 | −0.0033 | 0.065515 | −0.55046 | 1.782476 |
| 546 | 6.13E−05 | −0.00339 | 0.067334 | −0.56683 | 1.837863 |
| 547 | 5.88E−05 | −0.00326 | 0.06498 | −0.54756 | 1.780063 |
| 548 | 6.12E−05 | −0.0034 | 0.067762 | −0.57302 | 1.867113 |
| 549 | 6.43E−05 | −0.00357 | 0.071285 | −0.60525 | 1.977076 |
| 550 | 6.68E−05 | −0.0037 | 0.074189 | −0.63207 | 2.069283 |
| 551 | 7.06E−05 | −0.00392 | 0.078522 | −0.67157 | 2.203246 |
| 553 | 7.54E−05 | −0.00417 | 0.083769 | −0.71863 | 2.360031 |
| 554 | 7.61E−05 | −0.00421 | 0.084536 | −0.72545 | 2.382651 |
| 555 | 7.63E−05 | −0.00423 | 0.085006 | −0.73121 | 2.407008 |
| 556 | 7.89E−05 | −0.00437 | 0.087777 | −0.75607 | 2.490055 |
| 557 | 7.95E−05 | −0.00441 | 0.088685 | −0.76558 | 2.525966 |
| 558 | 8.28E−05 | −0.00458 | 0.092339 | −0.79869 | 2.637121 |
| 559 | 8.59E−05 | −0.00475 | 0.095833 | −0.83058 | 2.744849 |
| 560 | 8.94E−05 | −0.00495 | 0.099722 | −0.86558 | 2.861406 |
| 562 | 8.94E−05 | −0.00495 | 0.100036 | −0.8702 | 2.881966 |
| 563 | 9.4E−05 | −0.0052 | 0.10508 | −0.91576 | 3.034751 |
| 564 | 9.41E−05 | −0.00521 | 0.105304 | −0.91868 | 3.046926 |
| 565 | 9.45E−05 | −0.00523 | 0.10587 | −0.9249 | 3.07096 |
| 566 | 9.77E−05 | −0.0054 | 0.109328 | −0.95621 | 3.175812 |
| 567 | 0.000101 | −0.00557 | 0.112771 | −0.98789 | 3.283426 |
| 568 | 9.92E−05 | −0.00549 | 0.111225 | −0.97527 | 3.245027 |
| 569 | 0.000101 | −0.00558 | 0.113051 | −0.99206 | 3.301849 |
| 571 | 1E−04 | −0.00553 | 0.112212 | −0.98546 | 3.282376 |
| 572 | 0.000101 | −0.00558 | 0.113229 | −0.99562 | 3.31904 |
| 573 | 0.000102 | −0.00564 | 0.114549 | −1.00955 | 3.371655 |
| 574 | 0.000101 | −0.00562 | 0.114556 | −1.01194 | 3.386525 |
| 575 | 0.000103 | −0.0057 | 0.116086 | −1.02609 | 3.43461 |
| 576 | 0.000101 | −0.00561 | 0.114392 | −1.01181 | 3.389562 |
| 577 | 0.000102 | −0.00565 | 0.115183 | −1.01972 | 3.417435 |
| 578 | 0.000101 | −0.00561 | 0.114618 | −1.01614 | 3.409181 |
| 580 | 0.000103 | −0.00572 | 0.116673 | −1.03405 | 3.465918 |
| 581 | 0.000103 | −0.0057 | 0.116271 | −1.03069 | 3.454573 |
| 582 | 0.000101 | −0.00562 | 0.114838 | −1.01916 | 3.419435 |
| 583 | 9.99E−05 | −0.00556 | 0.113583 | −1.00887 | 3.387451 |
| 584 | 0.000101 | −0.00561 | 0.114562 | −1.01785 | 3.417179 |
| 585 | 0.000103 | −0.00571 | 0.116668 | −1.03626 | 3.476085 |
| 586 | 0.000103 | −0.0057 | 0.116419 | −1.03442 | 3.47045 |
| 587 | 0.000101 | −0.00564 | 0.115212 | −1.02422 | 3.437835 |
| 589 | 9.95E−05 | −0.00553 | 0.113089 | −1.00568 | 3.377071 |
| 590 | 0.0001 | −0.00557 | 0.11394 | −1.01343 | 3.402616 |
| 591 | 9.99E−05 | −0.00555 | 0.113548 | −1.01017 | 3.391936 |
| 592 | 0.0001 | −0.00558 | 0.114077 | −1.01489 | 3.40705 |
| 593 | 0.0001 | −0.00558 | 0.114094 | −1.01491 | 3.406202 |
| 594 | 0.0001 | −0.00556 | 0.113665 | −1.01104 | 3.392857 |
| 595 | 0.0001 | −0.00557 | 0.113731 | −1.01143 | 3.393064 |
| 596 | 9.92E−05 | −0.00551 | 0.112567 | −1.00087 | 3.357127 |
| 598 | 9.83E−05 | −0.00546 | 0.111594 | −0.99225 | 3.328372 |
| 599 | 9.82E−05 | −0.00546 | 0.111515 | −0.99161 | 3.326136 |
| 600 | 9.79E−05 | −0.00544 | 0.111094 | −0.98798 | 3.314292 |
| 601 | 9.77E−05 | −0.00543 | 0.110927 | −0.98636 | 3.308254 |
| 602 | 9.79E−05 | −0.00544 | 0.111083 | −0.98755 | 3.311268 |
| 603 | 9.79E−05 | −0.00544 | 0.111054 | −0.98751 | 3.311693 |
| 604 | 9.87E−05 | −0.00548 | 0.11191 | −0.99459 | 3.333014 |
| 605 | 9.81E−05 | −0.00544 | 0.111158 | −0.98762 | 3.308907 |
| 607 | 9.76E−05 | −0.00542 | 0.110569 | −0.98234 | 3.291167 |
| 608 | 9.73E−05 | −0.0054 | 0.110242 | −0.97934 | 3.280654 |
| 609 | 9.69E−05 | −0.00538 | 0.109748 | −0.97475 | 3.264641 |
| 610 | 9.67E−05 | −0.00536 | 0.109511 | −0.97282 | 3.258594 |
| 611 | 9.52E−05 | −0.00528 | 0.107897 | −0.9585 | 3.211098 |
| 612 | 9.42E−05 | −0.00523 | 0.106697 | −0.94745 | 3.172995 |
| 613 | 9.45E−05 | −0.00525 | 0.107051 | −0.95067 | 3.183522 |
| 615 | 9.39E−05 | −0.00521 | 0.106231 | −0.94305 | 3.157014 |
| 616 | 9.24E−05 | −0.00512 | 0.104553 | −0.92797 | 3.106366 |
| 617 | 9.35E−05 | −0.00519 | 0.105841 | −0.93974 | 3.145798 |
| 618 | 9.36E−05 | −0.00519 | 0.105913 | −0.94046 | 3.148107 |
| 619 | 9.27E−05 | −0.00514 | 0.104862 | −0.9312 | 3.11759 |
| 620 | 9.21E−05 | −0.00511 | 0.104162 | −0.92465 | 3.094636 |
| 621 | 9.26E−05 | −0.00513 | 0.10476 | −0.93047 | 3.114943 |
| 622 | 9.16E−05 | −0.00508 | 0.10373 | −0.92159 | 3.086222 |
| 624 | 9.28E−05 | −0.00515 | 0.10501 | −0.93307 | 3.123917 |
| 625 | 9.22E−05 | −0.00511 | 0.104425 | −0.92843 | 3.110281 |
| 626 | 9.34E−05 | −0.00518 | 0.10574 | −0.9402 | 3.148908 |
| 627 | 9E−05 | −0.00499 | 0.101836 | −0.90524 | 3.032218 |
| 628 | 9.26E−05 | −0.00513 | 0.104779 | −0.93189 | 3.121454 |
| 629 | 9.02E−05 | −0.005 | 0.102161 | −0.90901 | 3.046935 |
| 630 | 9.02E−05 | −0.005 | 0.102207 | −0.90987 | 3.050953 |
| 632 | 8.88E−05 | −0.00492 | 0.100602 | −0.89558 | 3.003324 |
| 633 | 8.91E−05 | −0.00494 | 0.100945 | −0.89884 | 3.014589 |
| 634 | 8.73E−05 | −0.00485 | 0.099156 | −0.88423 | 2.970007 |
| 635 | 8.63E−05 | −0.00479 | 0.098156 | −0.8759 | 2.943863 |
| 636 | 8.53E−05 | −0.00474 | 0.097079 | −0.86649 | 2.912982 |
| 637 | 8.47E−05 | −0.00471 | 0.096437 | −0.86102 | 2.89536 |
| 638 | 8.36E−05 | −0.00465 | 0.095186 | −0.85011 | 2.859707 |
| 639 | 8.48E−05 | −0.00471 | 0.096487 | −0.86213 | 2.900463 |
| 641 | 8.41E−05 | −0.00467 | 0.095672 | −0.85492 | 2.876525 |
| 642 | 8.4E−05 | −0.00466 | 0.095491 | −0.85334 | 2.871114 |
| 643 | 8.44E−05 | −0.00468 | 0.095878 | −0.85677 | 2.882171 |
| 644 | 8.57E−05 | −0.00475 | 0.097315 | −0.86981 | 2.925658 |
| 645 | 8.49E−05 | −0.00471 | 0.096474 | −0.86257 | 2.902287 |
| 646 | 8.47E−05 | −0.0047 | 0.096244 | −0.86078 | 2.897092 |
| 647 | 8.5E−05 | −0.00471 | 0.096599 | −0.86467 | 2.912179 |
| 649 | 8.41E−05 | −0.00467 | 0.095608 | −0.85599 | 2.88374 |
| 650 | 8.42E−05 | −0.00467 | 0.095598 | −0.85568 | 2.881823 |
| 651 | 8.43E−05 | −0.00467 | 0.09557 | −0.85508 | 2.878563 |
| 652 | 8.39E−05 | −0.00465 | 0.095138 | −0.85158 | 2.86779 |
| 653 | 8.4E−05 | −0.00465 | 0.095161 | −0.85149 | 2.866442 |
| 654 | 8.33E−05 | −0.00461 | 0.094382 | −0.84459 | 2.843805 |
| 655 | 8.3E−05 | −0.00459 | 0.093915 | −0.84045 | 2.830185 |
| 657 | 8.2E−05 | −0.00454 | 0.092843 | −0.83087 | 2.798494 |
| 658 | 8.19E−05 | −0.00453 | 0.092688 | −0.82983 | 2.796498 |
| 659 | 8.14E−05 | −0.0045 | 0.092084 | −0.82418 | 2.777385 |
| 660 | 8.35E−05 | −0.00461 | 0.094256 | −0.84318 | 2.839244 |
| 661 | 8.28E−05 | −0.00458 | 0.093547 | −0.83741 | 2.82239 |
| 662 | 8.16E−05 | −0.00451 | 0.092233 | −0.82602 | 2.786572 |
| 663 | 8.07E−05 | −0.00446 | 0.091198 | −0.8169 | 2.757639 |
| 665 | 7.56E−05 | −0.00418 | 0.085667 | −0.76808 | 2.598878 |
| 666 | 7.66E−05 | −0.00423 | 0.086646 | −0.77696 | 2.630298 |
| 667 | 7.95E−05 | −0.00439 | 0.089664 | −0.80323 | 2.716949 |
| 668 | 7.77E−05 | −0.00429 | 0.087737 | −0.78654 | 2.665183 |
| 669 | 7.66E−05 | −0.00423 | 0.086568 | −0.77677 | 2.637415 |
| 670 | 7.39E−05 | −0.00408 | 0.083545 | −0.75023 | 2.553145 |
| 671 | 7.48E−05 | −0.00412 | 0.084271 | −0.75559 | 2.569774 |
| 673 | 7.57E−05 | −0.00417 | 0.085262 | −0.76515 | 2.606941 |
| 674 | 7.5E−05 | −0.00413 | 0.084383 | −0.75718 | 2.583973 |
| 675 | 7.52E−05 | −0.00414 | 0.084533 | −0.75911 | 2.596441 |
| 676 | 7.57E−05 | −0.00416 | 0.085175 | −0.76585 | 2.626597 |
| 677 | 7.45E−05 | −0.0041 | 0.08397 | −0.75625 | 2.603936 |
| 678 | 7.36E−05 | −0.00405 | 0.083038 | −0.74894 | 2.588651 |
| 679 | 7.32E−05 | −0.00403 | 0.082751 | −0.74777 | 2.595621 |
| 681 | 7.16E−05 | −0.00395 | 0.081125 | −0.73466 | 2.56334 |
| 682 | 7.23E−05 | −0.00398 | 0.081898 | −0.74254 | 2.600305 |
| 683 | 7.19E−05 | −0.00397 | 0.081645 | −0.74172 | 2.610397 |
| 684 | 6.89E−05 | −0.00381 | 0.078533 | −0.71562 | 2.538076 |
| 685 | 6.47E−05 | −0.00358 | 0.073988 | −0.67646 | 2.422253 |
| 686 | 6.41E−05 | −0.00354 | 0.073383 | −0.67251 | 2.423927 |
| 687 | 6.51E−05 | −0.0036 | 0.074667 | −0.68591 | 2.485556 |
| 689 | 6.56E−05 | −0.00364 | 0.075723 | −0.69854 | 2.54948 |
| 690 | 6.43E−05 | −0.00358 | 0.074772 | −0.69336 | 2.555533 |
| 691 | 6.32E−05 | −0.00352 | 0.073743 | −0.68658 | 2.553705 |
| 692 | 6.39E−05 | −0.00356 | 0.074846 | −0.6991 | 2.617518 |
| 693 | 6.43E−05 | −0.00359 | 0.0757 | −0.70971 | 2.676397 |
| 694 | 6.48E−05 | −0.00363 | 0.076667 | −0.72136 | 2.739266 |
| 695 | 6.32E−05 | −0.00354 | 0.075003 | −0.70812 | 2.715781 |
| 697 | 6.13E−05 | −0.00345 | 0.073571 | −0.69947 | 2.716308 |
| 698 | 6.51E−05 | −0.00367 | 0.078374 | −0.74649 | 2.90251 |
| 699 | 6.65E−05 | −0.00376 | 0.08031 | −0.76717 | 2.999299 |
| 700 | 6.73E−05 | −0.00381 | 0.081843 | −0.78531 | 3.09137 |
| 701 | 6.74E−05 | −0.00383 | 0.082329 | −0.79254 | 3.14232 |
| 702 | 7.09E−05 | −0.00403 | 0.086909 | −0.83779 | 3.324466 |
| 704 | 7.58E−05 | −0.00431 | 0.092733 | −0.89338 | 3.53934 |
| 705 | 7.18E−05 | −0.0041 | 0.088773 | −0.86144 | 3.462967 |
| 706 | 7.54E−05 | −0.00431 | 0.093387 | −0.9071 | 3.648578 |
| 707 | 7.07E−05 | −0.00407 | 0.088992 | −0.87293 | 3.570731 |
| 708 | 7.46E−05 | −0.0043 | 0.094187 | −0.92472 | 3.779653 |
| 709 | 7.58E−05 | −0.00438 | 0.096411 | −0.95049 | 3.904217 |
| 710 | 7.56E−05 | −0.00437 | 0.096338 | −0.95195 | 3.935468 |
| 712 | 7.7E−05 | −0.00446 | 0.098418 | −0.9741 | 4.039731 |
| 713 | 7.86E−05 | −0.00456 | 0.100894 | −1.00122 | 4.166169 |
| 714 | 8.17E−05 | −0.00474 | 0.104733 | −1.03912 | 4.323595 |
| 715 | 7.83E−05 | −0.00456 | 0.10125 | −1.01082 | 4.257408 |
| 716 | 7.84E−05 | −0.00457 | 0.101878 | −1.02013 | 4.319886 |
| 717 | 8.46E−05 | −0.00491 | 0.108834 | −1.08426 | 4.557942 |
| 718 | 7.94E−05 | −0.00466 | 0.104352 | −1.05099 | 4.486816 |
| 720 | 7.31E−05 | −0.00432 | 0.09794 | −0.99785 | 4.341699 |
| 721 | 7.26E−05 | −0.0043 | 0.097669 | −0.99811 | 4.369013 |
| 722 | 6.93E−05 | −0.00414 | 0.094994 | −0.97983 | 4.342845 |
| 723 | 6.33E−05 | −0.00383 | 0.088929 | −0.92943 | 4.203742 |
| 724 | 7.02E−05 | −0.00421 | 0.096961 | −1.00447 | 4.478777 |
| 725 | 6.38E−05 | −0.00388 | 0.090781 | −0.95437 | 4.34389 |
| 727 | 6.68E−05 | −0.00405 | 0.09455 | −0.99137 | 4.491608 |
| 728 | 6.98E−05 | −0.00423 | 0.098568 | −1.03108 | 4.648288 |
| 729 | 6.43E−05 | −0.00393 | 0.092536 | −0.97834 | 4.48956 |
| 730 | 6.28E−05 | −0.00386 | 0.091138 | −0.96796 | 4.473673 |
| 731 | 5.87E−05 | −0.00365 | 0.08727 | −0.9374 | 4.39655 |
| 732 | 5.89E−05 | −0.00366 | 0.087747 | −0.94375 | 4.435014 |
| 733 | 5.73E−05 | −0.00358 | 0.086372 | −0.93425 | 4.422467 |
| 735 | 6.19E−05 | −0.00383 | 0.091405 | −0.9799 | 4.586389 |
| 736 | 5.37E−05 | −0.00339 | 0.082888 | −0.90766 | 4.368362 |
| 737 | 4.85E−05 | −0.00312 | 0.077677 | −0.8643 | 4.243134 |
| 738 | 4.13E−05 | −0.00274 | 0.070242 | −0.8009 | 4.049496 |
| 739 | 4.16E−05 | −0.00275 | 0.070175 | −0.79932 | 4.047421 |
| 740 | 3.87E−05 | −0.00259 | 0.067159 | −0.77364 | 3.970592 |
| 742 | 3.16E−05 | −0.00222 | 0.059771 | −0.71027 | 3.773417 |
| 743 | 2.78E−05 | −0.00201 | 0.055589 | −0.6736 | 3.657443 |
| 744 | 2.4E−05 | −0.0018 | 0.051271 | −0.6348 | 3.531819 |
| 745 | 1.9E−05 | −0.00153 | 0.045838 | −0.58747 | 3.382161 |
| 746 | 1.78E−05 | −0.00146 | 0.044407 | −0.57431 | 3.340486 |
| 747 | 1.05E−05 | −0.00108 | 0.037 | −0.51173 | 3.148341 |
| 749 | 8.27E−06 | −0.00095 | 0.034479 | −0.49001 | 3.082357 |
| 750 | 1.3E−06 | −0.00057 | 0.026893 | −0.42344 | 2.868338 |
| 751 | 3.85E−06 | −0.00071 | 0.029615 | −0.44763 | 2.950044 |
| 752 | 4.6E−06 | −0.00075 | 0.030425 | −0.455 | 2.976417 |
| 753 | 3.36E−06 | −0.00069 | 0.029276 | −0.44625 | 2.954286 |
| 754 | 8.9E−06 | −0.00099 | 0.03538 | −0.50092 | 3.137631 |
| 756 | 1.01E−05 | −0.00105 | 0.036586 | −0.5118 | 3.175698 |
| 757 | 3.82E−06 | −0.0007 | 0.029522 | −0.44849 | 2.966122 |
| 758 | 2.91E−07 | −0.00051 | 0.025668 | −0.41469 | 2.856645 |
| 759 | 5.43E−06 | −0.00078 | 0.031054 | −0.46174 | 3.009793 |
| 760 | 1.2E−06 | −0.00056 | 0.026766 | −0.42513 | 2.893692 |
| 761 | 4.8E−06 | −0.00076 | 0.03085 | −0.46246 | 3.021194 |
| 762 | −2E−06 | −0.00039 | 0.023539 | −0.39883 | 2.816852 |
| 764 | 2.96E−06 | −0.00067 | 0.029228 | −0.45076 | 2.994253 |
| 765 | 3.43E−06 | −0.00069 | 0.029731 | −0.45563 | 3.013332 |
| 766 | 6.49E−06 | −0.00086 | 0.033273 | −0.4885 | 3.128139 |
| 767 | 6.81E−06 | −0.00089 | 0.033987 | −0.49689 | 3.163971 |
| 768 | 7.7E−06 | −0.00094 | 0.035139 | −0.50846 | 3.20805 |
| 769 | 8.09E−06 | −0.00096 | 0.035724 | −0.51477 | 3.23358 |
| 771 | 8.38E−06 | −0.00098 | 0.03616 | −0.51949 | 3.252746 |
| 772 | 1.08E−05 | −0.00111 | 0.038864 | −0.54419 | 3.337423 |
| 773 | 9.13E−06 | −0.00102 | 0.03705 | −0.52833 | 3.286764 |
| 774 | 9.63E−06 | −0.00105 | 0.037638 | −0.53397 | 3.307517 |
| 775 | 8.17E−06 | −0.00097 | 0.035946 | −0.51917 | 3.261239 |
| 776 | 4.94E−06 | −0.00079 | 0.032454 | −0.48876 | 3.164311 |
| 778 | 4.9E−06 | −0.00078 | 0.032007 | −0.48364 | 3.145674 |
| 779 | −9.5E−07 | −0.00047 | 0.025877 | −0.43071 | 2.977203 |
| 780 | −9.9E−07 | −0.00047 | 0.026178 | −0.43549 | 3.001548 |
| 781 | −1.7E−06 | −0.00044 | 0.025576 | −0.43141 | 2.993188 |
| 782 | −1.8E−07 | −0.00052 | 0.02716 | −0.44537 | 3.040078 |
| 783 | 8.37E−07 | −0.00057 | 0.028236 | −0.45497 | 3.072487 |
| 785 | 3.34E−06 | −0.0007 | 0.030821 | −0.47748 | 3.145915 |
| 786 | 6.98E−07 | −0.00055 | 0.027702 | −0.44916 | 3.05154 |
| 787 | 7.5E−06 | −0.00092 | 0.034989 | −0.51357 | 3.264056 |
| 788 | 7.39E−06 | −0.00092 | 0.035187 | −0.517 | 3.281592 |
| 789 | 3.48E−06 | −0.00071 | 0.030982 | −0.48015 | 3.161936 |
| 790 | −4E−07 | −0.0005 | 0.02657 | −0.4405 | 3.030154 |
| 792 | −1.2E−06 | −0.00045 | 0.025441 | −0.42939 | 2.990532 |
| 793 | 1.16E−06 | −0.00057 | 0.027943 | −0.45193 | 3.067044 |
| 794 | 3.96E−06 | −0.00072 | 0.03102 | −0.47969 | 3.160729 |
| 795 | 5.75E−06 | −0.00082 | 0.033097 | −0.49891 | 3.227042 |
| 796 | 1.42E−05 | −0.00127 | 0.042122 | −0.57837 | 3.487414 |
| 797 | 1.22E−05 | −0.00117 | 0.040211 | −0.56283 | 3.44108 |
| 799 | 1.44E−05 | −0.00129 | 0.042468 | −0.58269 | 3.50634 |
| 800 | 1.48E−05 | −0.00131 | 0.042942 | −0.58711 | 3.521422 |
| 801 | 1.49E−05 | −0.00131 | 0.043009 | −0.58755 | 3.522374 |
| 802 | 1.71E−05 | −0.00143 | 0.045384 | −0.60876 | 3.592387 |
| 803 | 2.02E−05 | −0.0016 | 0.048714 | −0.63802 | 3.687501 |
| 804 | 1.74E−05 | −0.00145 | 0.045643 | −0.6108 | 3.597175 |
| 806 | 1.89E−05 | −0.00153 | 0.047266 | −0.62513 | 3.643663 |
| 807 | 1.99E−05 | −0.00159 | 0.048563 | −0.63763 | 3.687525 |
| 808 | 2.4E−05 | −0.00181 | 0.053022 | −0.67721 | 3.817074 |
| 809 | 2.44E−05 | −0.00183 | 0.053486 | −0.68157 | 3.831509 |
| 810 | 2.61E−05 | −0.00192 | 0.055455 | −0.69973 | 3.893204 |
| 812 | 2.53E−05 | −0.00188 | 0.054653 | −0.69271 | 3.869275 |
| 813 | 2.8E−05 | −0.00203 | 0.057533 | −0.71803 | 3.951172 |
| 814 | 3.08E−05 | −0.00218 | 0.0606 | −0.74511 | 4.039313 |
| 815 | 3.26E−05 | −0.00228 | 0.062538 | −0.76221 | 4.094421 |
| 816 | 3.39E−05 | −0.00235 | 0.063988 | −0.77511 | 4.136071 |
| 817 | 3.74E−05 | −0.00253 | 0.06767 | −0.80711 | 4.238253 |
| 868 | 3.42E−05 | −0.00241 | 0.066389 | −0.81061 | 4.296326 |
| 869 | 3.36E−05 | −0.00238 | 0.065834 | −0.80591 | 4.279801 |
| 870 | 3.43E−05 | −0.00241 | 0.066383 | −0.80983 | 4.288023 |
| 872 | 3.55E−05 | −0.00247 | 0.067575 | −0.81961 | 4.315654 |
| 873 | 3.72E−05 | −0.00256 | 0.069411 | −0.8357 | 4.365458 |
| 874 | 3.56E−05 | −0.00248 | 0.067856 | −0.82235 | 4.319945 |
| 875 | 3.68E−05 | −0.00255 | 0.069108 | −0.8329 | 4.349746 |
| 876 | 3.59E−05 | −0.00249 | 0.067933 | −0.82099 | 4.302023 |
| 878 | 3.67E−05 | −0.00252 | 0.067993 | −0.81752 | 4.273906 |
| 879 | 3.28E−05 | −0.00232 | 0.06419 | −0.78502 | 4.16669 |
| 880 | 3.23E−05 | −0.00229 | 0.063625 | −0.77939 | 4.141533 |
| 881 | 3.33E−05 | −0.00235 | 0.064609 | −0.78633 | 4.153372 |
| 882 | 3.73E−05 | −0.00255 | 0.068197 | −0.81389 | 4.225027 |
| 883 | 3.12E−05 | −0.00221 | 0.061123 | −0.74856 | 3.995987 |
| 885 | 3.07E−05 | −0.00218 | 0.060509 | −0.74193 | 3.964613 |
| 886 | 3.62E−05 | −0.00247 | 0.066341 | −0.79235 | 4.120897 |
| 887 | 3.75E−05 | −0.00254 | 0.067581 | −0.80141 | 4.138439 |
| 888 | 3.97E−05 | −0.00266 | 0.069723 | −0.81817 | 4.179825 |
| 889 | 4.29E−05 | −0.00281 | 0.072431 | −0.83766 | 4.22236 |
| 891 | 4.85E−05 | −0.00311 | 0.078344 | −0.88818 | 4.37579 |
| 892 | 4.26E−05 | −0.00277 | 0.07112 | −0.81955 | 4.127045 |
| 893 | 4.86E−05 | −0.00309 | 0.077274 | −0.871 | 4.27908 |
| 894 | 5.33E−05 | −0.00334 | 0.081851 | −0.908 | 4.382111 |
| 895 | 4.78E−05 | −0.00305 | 0.07614 | −0.85723 | 4.206837 |
| 897 | 5.29E−05 | −0.00331 | 0.081134 | −0.89771 | 4.318879 |
| 898 | 5.03E−05 | −0.00317 | 0.078084 | −0.86832 | 4.206144 |
| 899 | 4.98E−05 | −0.00314 | 0.077405 | −0.86016 | 4.164359 |
| 900 | 4.88E−05 | −0.00307 | 0.075622 | −0.84004 | 4.075282 |
| 901 | 4.98E−05 | −0.00311 | 0.076102 | −0.84001 | 4.052564 |
| 903 | 5.82E−05 | −0.00355 | 0.084578 | −0.91052 | 4.261017 |
| 904 | 4.7E−05 | −0.00294 | 0.071886 | −0.79433 | 3.858493 |
| 905 | 5.13E−05 | −0.00316 | 0.075952 | −0.82606 | 3.940528 |
| 906 | 4.64E−05 | −0.00288 | 0.069939 | −0.76819 | 3.726319 |
| 907 | 4.76E−05 | −0.00293 | 0.070836 | −0.77349 | 3.727803 |
| 908 | 4.67E−05 | −0.00289 | 0.069725 | −0.76153 | 3.673618 |
| 910 | 3.85E−05 | −0.00243 | 0.060376 | −0.6755 | 3.371417 |
| 911 | 3.8E−05 | −0.00241 | 0.059699 | −0.66706 | 3.327561 |
| 912 | 3.59E−05 | −0.00227 | 0.056346 | −0.631 | 3.179663 |
| 913 | 3.26E−05 | −0.00208 | 0.052203 | −0.59123 | 3.033071 |
| 914 | 2.3E−05 | −0.00154 | 0.041036 | −0.48791 | 2.671812 |
| 916 | 2.52E−05 | −0.00165 | 0.042975 | −0.50221 | 2.703404 |
| 917 | 1.97E−05 | −0.00135 | 0.036721 | −0.44435 | 2.498506 |
| 918 | 1.54E−05 | −0.0011 | 0.031459 | −0.39432 | 2.317154 |
| 919 | 8.57E−06 | −0.00073 | 0.02395 | −0.32661 | 2.085029 |
| 920 | 7.79E−06 | −0.00067 | 0.022331 | −0.30793 | 2.004423 |
| 922 | 1.06E−05 | −0.00081 | 0.024763 | −0.32599 | 2.048103 |
| 923 | 1.11E−05 | −0.00084 | 0.02548 | −0.33255 | 2.06683 |
| 924 | 1E−05 | −0.00079 | 0.024304 | −0.3218 | 2.027487 |
| 925 | 7.33E−06 | −0.00062 | 0.02062 | −0.28563 | 1.89429 |
| 926 | 7.63E−06 | −0.00065 | 0.021222 | −0.29191 | 1.915853 |
| 928 | 9.65E−06 | −0.00076 | 0.023562 | −0.31326 | 1.986524 |
| 929 | 1.27E−05 | −0.00092 | 0.026912 | −0.34311 | 2.084423 |
| 930 | 2.26E−05 | −0.00147 | 0.037956 | −0.44257 | 2.416717 |
| 931 | 1.53E−05 | −0.00107 | 0.029921 | −0.37104 | 2.179892 |
| 932 | 1.98E−05 | −0.00132 | 0.035091 | −0.41794 | 2.337723 |
| 934 | 1.81E−05 | −0.00122 | 0.033166 | −0.40172 | 2.288738 |
| 935 | 1.79E−05 | −0.0012 | 0.032504 | −0.39453 | 2.261763 |
| 936 | 1.86E−05 | −0.00123 | 0.032994 | −0.39815 | 2.272975 |
| 937 | 1.46E−05 | −0.00102 | 0.02879 | −0.36212 | 2.160061 |
| 938 | 1.4E−05 | −0.00098 | 0.028081 | −0.35619 | 2.143495 |
| 940 | 7.67E−06 | −0.00066 | 0.022087 | −0.3075 | 1.999545 |
| 941 | 7.49E−06 | −0.00065 | 0.022038 | −0.30852 | 2.010389 |
| 942 | 5.2E−06 | −0.00054 | 0.01988 | −0.29153 | 1.963608 |
| 943 | 7.81E−06 | −0.00068 | 0.023015 | −0.3216 | 2.073183 |
| 944 | 7.94E−06 | −0.00069 | 0.023238 | −0.32495 | 2.092021 |
| 946 | 1.48E−05 | −0.00107 | 0.030981 | −0.39574 | 2.335694 |
| 947 | 6.6E−06 | −0.00061 | 0.021671 | −0.31256 | 2.06287 |
| 948 | 1.44E−05 | −0.00104 | 0.030444 | −0.39244 | 2.335884 |
| 949 | 1.18E−05 | −0.0009 | 0.027631 | −0.36867 | 2.264778 |
| 950 | 1.28E−05 | −0.00094 | 0.02851 | −0.37607 | 2.290631 |
| 952 | 1.53E−05 | −0.00107 | 0.031052 | −0.39889 | 2.37043 |
| 953 | 1.21E−05 | −0.00089 | 0.027156 | −0.3639 | 2.257812 |
| 954 | 1.68E−05 | −0.00115 | 0.032615 | −0.41506 | 2.439193 |
| 955 | 5.12E−06 | −0.0005 | 0.019427 | −0.29728 | 2.052143 |
| 956 | 9.78E−07 | −0.00028 | 0.014992 | −0.25907 | 1.932672 |
| 958 | −7.8E−06 | 0.000191 | 0.005646 | −0.17783 | 1.673321 |
| 959 | 2.05E−06 | −0.00032 | 0.015594 | −0.26416 | 1.956079 |
| 960 | 2.96E−06 | −0.00035 | 0.016129 | −0.26798 | 1.969154 |
| 961 | 1.28E−06 | −0.00026 | 0.014306 | −0.25294 | 1.926629 |
| 962 | −7.8E−07 | −0.00015 | 0.012117 | −0.2348 | 1.874312 |
| 964 | −3.1E−06 | −2.6E−05 | 0.009703 | −0.21516 | 1.819637 |
| 965 | −9.2E−06 | 0.000302 | 0.00322 | −0.15952 | 1.645767 |
| 966 | −1E−05 | 0.000346 | 0.002403 | −0.15343 | 1.632649 |
| 967 | −8E−06 | 0.000226 | 0.005148 | −0.18161 | 1.741866 |
| 968 | −7.9E−06 | 0.000218 | 0.005443 | −0.18578 | 1.763357 |
| 970 | −1.3E−05 | 0.000494 | −0.00011 | −0.13726 | 1.606859 |
| 971 | −1.9E−05 | 0.000844 | −0.00712 | −0.07589 | 1.408272 |
| 972 | −1.8E−05 | 0.000784 | −0.00594 | −0.08678 | 1.446719 |
| 973 | −1.9E−05 | 0.000847 | −0.00711 | −0.07795 | 1.423279 |
| 974 | −2.4E−05 | 0.001092 | −0.01174 | −0.04048 | 1.312139 |
| 976 | −2E−05 | 0.000865 | −0.00701 | −0.08452 | 1.463871 |
| 977 | −2.2E−05 | 0.000953 | −0.00876 | −0.06998 | 1.419559 |
| 978 | −2.3E−05 | 0.001007 | −0.00988 | −0.06056 | 1.390559 |
| 979 | −2.7E−05 | 0.00125 | −0.01464 | −0.01993 | 1.262143 |
| 980 | −2.8E−05 | 0.001329 | −0.01622 | −0.00675 | 1.221689 |
| 982 | −2.6E−05 | 0.001221 | −0.01401 | −0.02732 | 1.292614 |
| 983 | −3.1E−05 | 0.001475 | −0.01899 | 0.015134 | 1.158462 |
| 984 | −3.6E−05 | 0.001713 | −0.02356 | 0.053227 | 1.041181 |
| 985 | −3.5E−05 | 0.001685 | −0.02302 | 0.048093 | 1.059604 |
| 986 | −3.2E−05 | 0.001532 | −0.01987 | 0.01904 | 1.159141 |
| 988 | −3.6E−05 | 0.001738 | −0.02401 | 0.055253 | 1.041394 |
| 989 | −3.3E−05 | 0.00156 | −0.02067 | 0.027128 | 1.129143 |
| 990 | −3.5E−05 | 0.001724 | −0.02405 | 0.057341 | 1.028696 |
| 991 | −3.6E−05 | 0.001757 | −0.02461 | 0.061091 | 1.020039 |
| 992 | −3.4E−05 | 0.001654 | −0.02242 | 0.040435 | 1.09155 |
| 994 | −3.9E−05 | 0.001895 | −0.02728 | 0.083276 | 0.951489 |
| 995 | −3.6E−05 | 0.001771 | −0.02481 | 0.06124 | 1.023883 |
| 996 | −3.6E−05 | 0.001732 | −0.0241 | 0.055622 | 1.039978 |
| 997 | −3.4E−05 | 0.001618 | −0.02176 | 0.03431 | 1.111186 |
| 999 | −2.8E−05 | 0.001321 | −0.01614 | −0.01253 | 1.255154 |
| 1000 | −3.3E−05 | 0.001619 | −0.02221 | 0.041758 | 1.074219 |
| 1001 | −3.5E−05 | 0.001692 | −0.02343 | 0.050379 | 1.052092 |
| 1002 | −3.6E−05 | 0.001757 | −0.02476 | 0.062289 | 1.011764 |
| 1003 | −3E−05 | 0.001436 | −0.01831 | 0.004762 | 1.202379 |
| 1005 | −2.6E−05 | 0.00124 | −0.01438 | −0.02979 | 1.31443 |
| 1006 | −2.5E−05 | 0.001171 | −0.01307 | −0.04054 | 1.345615 |
| 1007 | −2.8E−05 | 0.001355 | −0.01674 | −0.00838 | 1.240438 |
| 1008 | −2.8E−05 | 0.001338 | −0.01651 | −0.00933 | 1.238277 |
| 1009 | −3.2E−05 | 0.001538 | −0.02045 | 0.024958 | 1.126718 |
| 1011 | −2.8E−05 | 0.001318 | −0.01624 | −0.01027 | 1.234529 |
| 1012 | −2.1E−05 | 0.000988 | −0.00993 | −0.06278 | 1.395022 |
| 1013 | −2.1E−05 | 0.000977 | −0.00985 | −0.06179 | 1.384047 |
| 1014 | −2.3E−05 | 0.001103 | −0.01226 | −0.04112 | 1.316511 |
| 1015 | −2E−05 | 0.000915 | −0.00887 | −0.06735 | 1.388877 |
| 1016 | −2.7E−05 | 0.00128 | −0.01585 | −0.00874 | 1.206247 |

The collected reflectance at the recording time Rᵣ′ is calibrated into the reflectance at targeting time Rₜ′ using the formula (11):

$${{R}_{t}}^{′} = [ \frac{{R}_{t 397}}{{R}_{r 397}} , \frac{{R}_{t 398}}{{R}_{r 398}} , \frac{{R}_{t 399}}{{R}_{r 399}} , ... , \frac{{R}_{t 1011}}{{R}_{r 1011}} ] ⊙ {{R}_{r}}^{′} \qquad ( 11 )$$

An example code for obtaining the coefficient of diurnal calibration model is provided in Table 2 below.

TABLE 2
Example code for obtaining the coefficient
of diurnal calibration model

```
import pandas as pd
import numpy as np
from sklearn.model_selection import train_test_split
from numpy import polyfit
# a list to store coefficient matrix
comatrix = [ ]
for i in path_name: ## iterate all files
  # read the data file
  data = pd.read_excel(‘./data_inventory/{ }’.format(i), index_col=0)
  # convert time into decimal format (begin)
  t1 = (np.array(data[data.columns.unique( )[0]]) %
10000).astype(‘int‘)
  t2 = (t1 − t1%100)/100 + t1%100/60
  reflectance = np.array(data[data.columns.unique( )[1]])
  # convert time into decimal format (finish)
  # abnormal data elimination (begin)
  n_t = [ ]
  n_reflectance = [ ]
  for j in np.unique(t2):
    sec_data = reflectance[j==t2]
    q751, q251 = np.percentile(np.array(sec_data), [75 ,25])
    mask1 = sec_data < q751
    mask2 = sec_data > q251
    mask = np.logical_and(mask1,mask2)
    n_t.extend(sec_data[mask])
    n_reflectance.extend([j]*len(sec_data[mask]))
  n_t = np.array(n_t)
  n_reflectance = np.array(n_reflectance)
  # abnormal data elimination (finish)
  # building the diurnal calibration model (begin)
  X_train, X_test, y_train, y_test = train_test_split(n_t,
n_reflectance, test_size=0.3)
  coeff = polyfit(train_x, train_y, 4)
  # building the diurnal calibration model (finish)
  # save the coefficients of diurnal calibration model
```

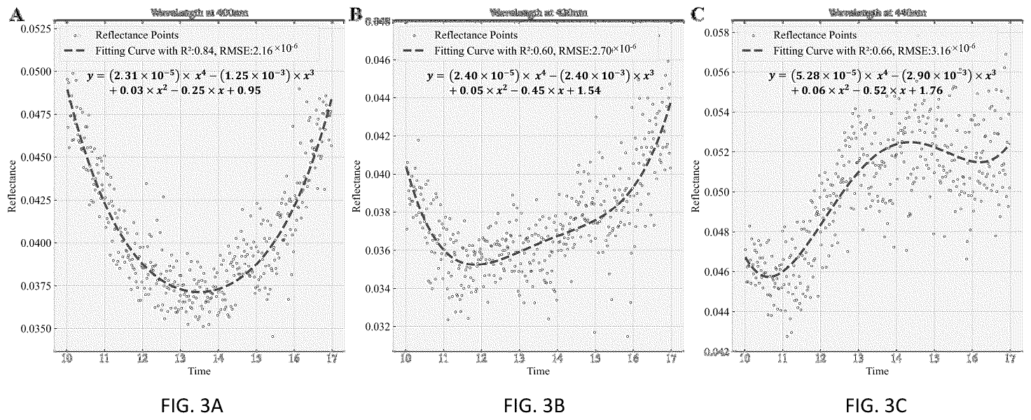

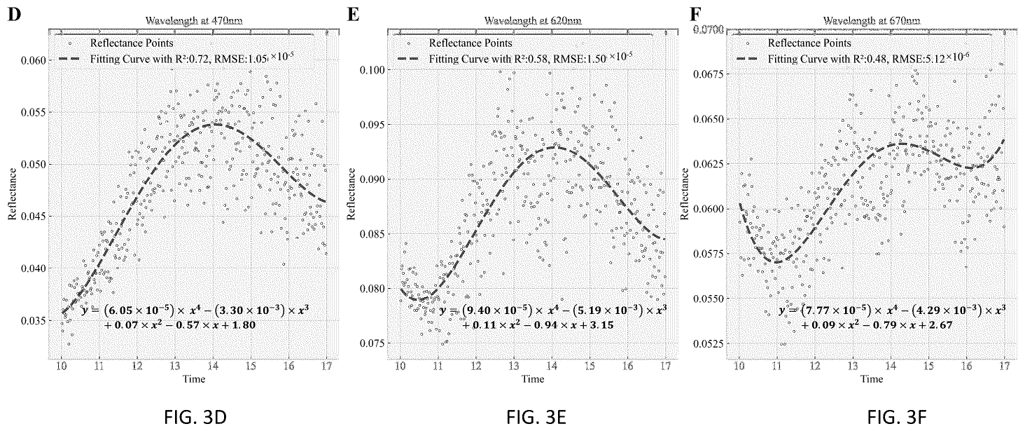

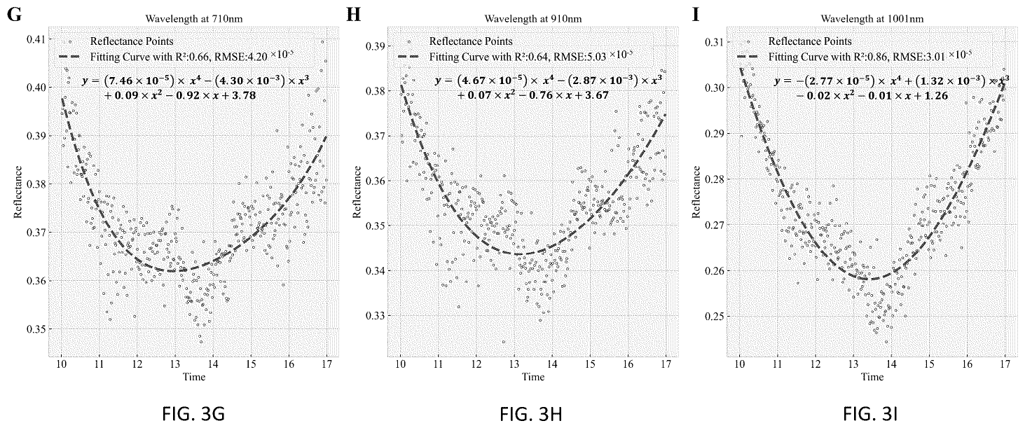

Specific wavelengths across the range of wavelengths were singled out in order to illustrate their distinct diurnal patterns. As shown in FIGS. 3A-3I, there were nine calibration curves of corresponding spectral bands, which were distributed throughout the entire spectral range. These curves provide reflectance (spectrum) vs. time of day each for a different wavelength. At around 400 nm (FIG. 3A), the diurnal pattern exhibited a V-shape with varying time, where the lowest reflectance occurred during the solar noon period. Under this circumstance, the testing phase also achieved an R² value of 0.84, indicating a satisfying modeling performance. As the wavelength increased (as shown in FIGS. 3B and 3C), the V-shaped pattern gradually shifted towards the opposite direction, with the reflectance at solar noon becoming the highest. During this progression, the calibration accuracy of the testing set decreased too. However, when the reverse V-shaped diurnal pattern stabilized around 470 nm, the fitting R² value increased to a promising level of 0.72. In FIGS. 3E and 3F, another stage of the diurnal pattern shifting was displayed, where the reverse V-shaped curves were bent towards the opposite direction again. Eventually, the diurnal pattern within the range of 700 nm to 1016 nm exhibited consistent and uniform V-shaped changes. Almost all of the prediction results within this range exhibited relatively stable and high R² value, with the exception of the calibration results at 910 nm, which did not perform as well. FIGS. 3D, 3G, 3H, and 3I are calibration curves for 470 nm, 710 nm, 910 nm, 1001 nm, respectively.

It should be appreciated that any of the curves in FIGS. 3A-3I can be used to make the diurnal transformation from one time of day (Time₁) to another time of day (Time₂). This process is made easier with a curve-fit mathematical expression relating the spectrum to the time of day. For example, suppose a spectrum was captured at 10:00 AM at 400 nm. Referring to FIG. 3A, the reflectance value at around 10:00 AM is about 0.0488. However, this captured spectrum needs to be converted to a different time, e.g., 2 PM. At 2 PM, the reflectance from FIG. 3A is about 0.0375. These two values can generate a ratio (0.0375/0.0488) which is about 0.768. Therefore, to calibrate the spectrum obtained at 10:00 AM to one at 2 PM, the spectrum at 10:00 AM is multiplied by 0.768. The sane procedure can be implemented from the polynomial that is identified in FIG. 3A. Using the polynomial, time 10 AM is input as the “x” and the corresponding “y₁” is determined. Then the target time (e.g., 2 PM) is input to obtain the “y₂” at that time. The ratio between y₁ and y₂ is then applied to the spectrum obtained at 10:00 AM to calibrate that spectrum to 2:00 PM. While a polynomial is described to provide a curve fit for the curves in FIGS. 3A-3I and for all other wavelengths (see Table 1), one or more other mathematical expression can be used to achieve a curve fit. It should be understood that the curve fit is simply a way to reduce noise from the scatter plots.

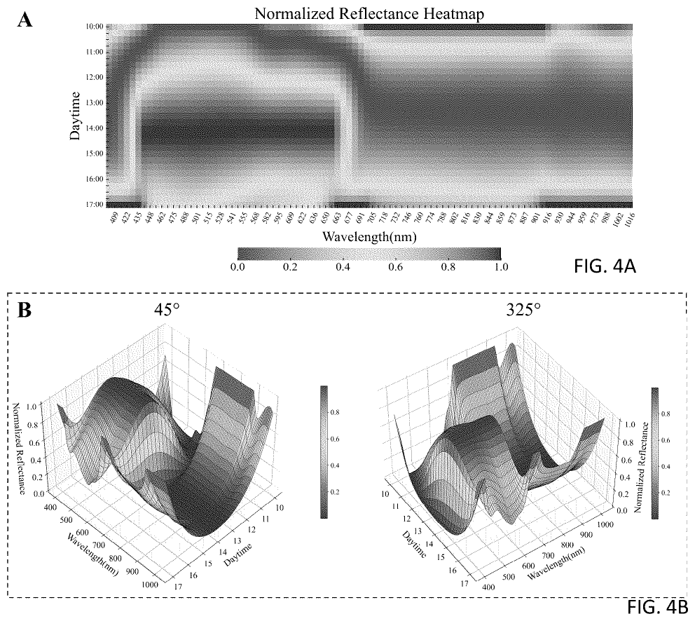

In general, it was apparent that there was a notable diurnal variation pattern among various segments in the VNIR range. FIGS. 4A and 4B are normalized reflectance heatmaps of diurnal changing pattern under varying times of day and wavelengths, FIG. 4A is the 2D heatmap; and FIG. 4B is the 3D surface maps at both 45° and 325° view angles. Specifically, FIGS. 4A and 4B provide both two-dimensional and three-dimensional visualizations to illustrate the variation surfaces with respect to daily time and wavelength. By applying reflectance normalization, the diurnal pattern within a single day was effectively highlighted. It was evident that within the three sections ranging from 400-470 nm, 470-670 nm, and 670-1000 nm, there were no distinct boundaries or abrupt changes, and the diurnal pattern changed smoothly from a V-shape to a reverse V-shape and vice versa.

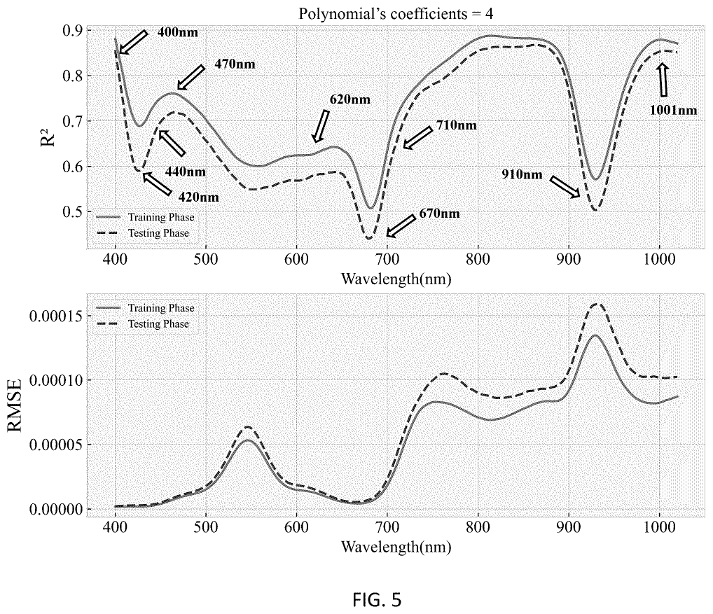

To further examine the whole picture of these calibration models, considering the daily time as the independent variable, the pattern of diurnal changes at specific wavelengths emerged as the primary factor in constructing calibration models. The complexity of diurnal variation magnitude significantly impacted the models established, emphasizing the importance of understanding these changes to create accurate and reliable models. FIG. 5 illustrates the training and testing results of diurnal calibration models utilizing a polynomial with a degree of four thereby providing the regression performance of the established diurnal calibration model in the VNIR spectral range. It can be observed that the R² values in the testing phase were slightly lower than those in the training phase, showing no sign of severe overfitting. Additionally, the relatively low values of the RMSE across all available wavelengths presented the high level of prediction accuracy of the established diurnal calibration model. Different responses occurred during the modeling of wavelength-time-related function. For example, the predictive ability of the diurnal calibration model reached a promising level at approximately 400 nm, 470 nm, 800 nm, and 1001 nm with the R² values above 0.7. There were also some curve valleys representing relatively low regression performance at several wavelengths, including 420 nm, 670 nm, and 910 nm. These R² curve dips indicate the areas where the model may struggle to accurately capture the underlying patterns. Overall, the majority of diurnal variances within the investigated daily time could be acquired by the established calibration model.

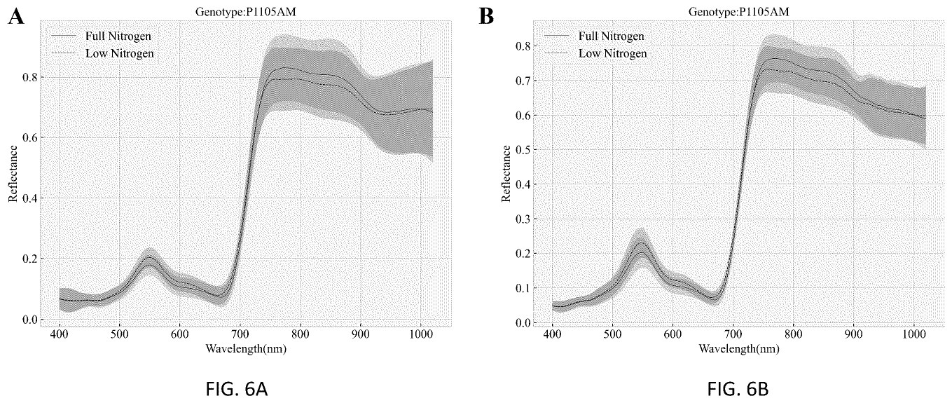

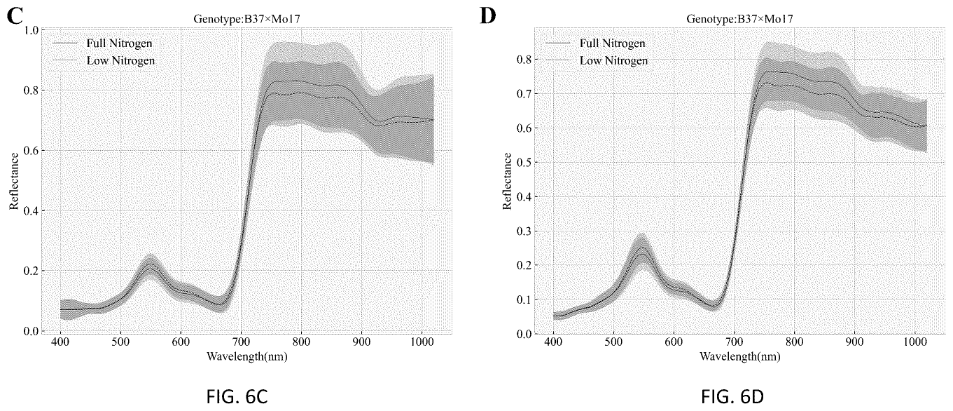

Based on the fact that this experiment involved two treatments—full and low nitrogen—the effectiveness of diurnal calibration was further verified by assessing whether the differences between the treatments were maintained while reducing the noise factor introduced via imaging time. Reference is made to FIGS. 6A-6D in which reflectance is plotted against wavelength for averaged spectra under full nitrogen and low nitrogen treatment from two corn genotypes' testing sets. Specifically, FIGS. 6A and 6C provide the original spectra; and FIGS. 6B and 6D provide the spectra after diurnal calibration to solar noon. The shaded areas indicate the standard deviation range. In both the P1105AM and the B37×Mo17 corn hybrids, it was observed that the averaged spectral reflectance derived from the low nitrogen treatment was higher than that derived from the full nitrogen treatment in the visible range, which suggested a decrease in visible light absorbance, indicating a decline in photosynthesis activity (FIGS. 6A and 6C). Differences between the two treatments could also be identified in the near-infrared range, where the lower reflectance value of the low nitrogen treatment suggests the possibility of leaf structure damage caused by nutrient deficiency. The shaded regions surrounding these average spectra, which indicated the dispersion of spectral data, overlapped significantly and covered a relatively large area. However, after diurnal spectral calibration, the variation in reflectance was significantly reduced across all wavelengths, as shown in FIGS. 6B and 6D. Notably, the spectral difference between the full and low nitrogen treatments was preserved. Reflectance peaks at around 550 nm became even sharper and more distinguishable following the calibration process.

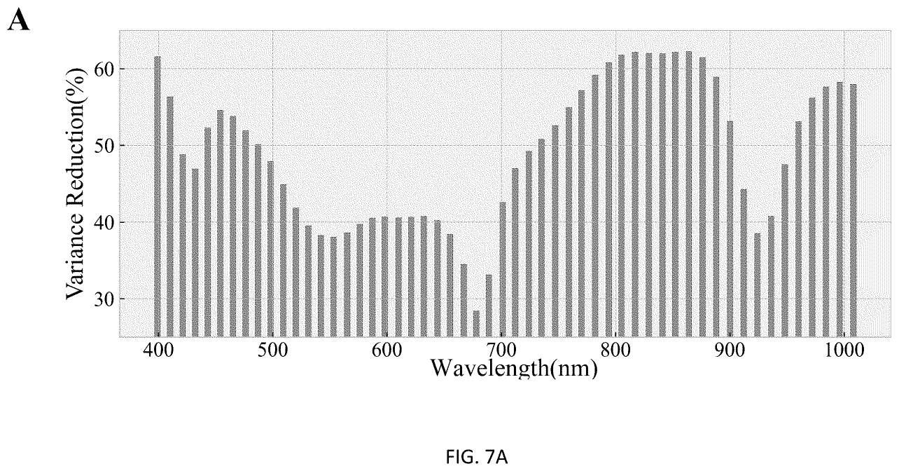

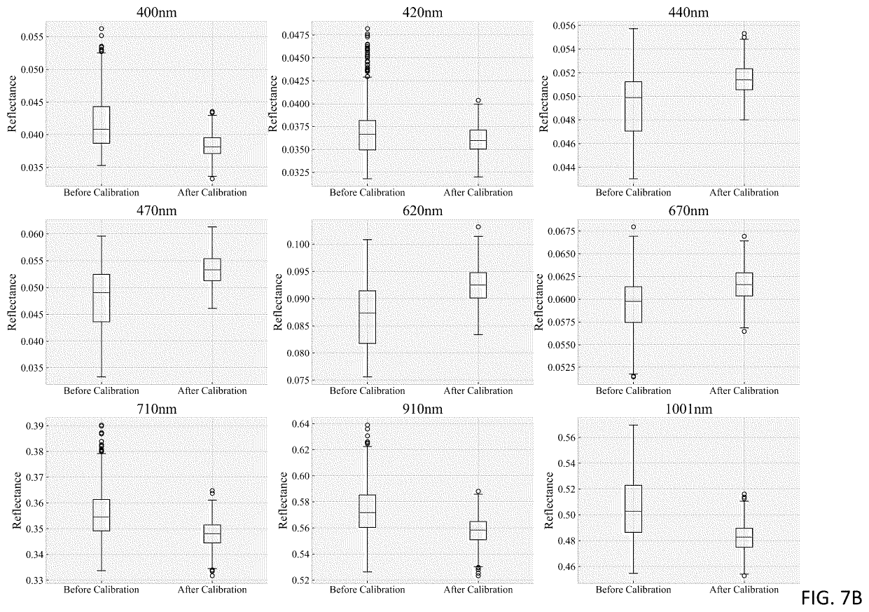

From a statistical analysis standpoint, the variance reduction ratio provided detailed information on the effectiveness of the diurnal calibration process. Making reference to FIGS. 7A and 7B, variance reduction ratio at different wavelengths are provided after diurnal calibration, where FIG. 7A provides the variance reduction ratio at all available wavelengths; and FIG. 7B provides statistical comparison between the before and after diurnal calibration based on reflectance at representative wavelengths. A closer examination of FIG. 7A reveals that the reflectance variances at all available wavelengths were reduced, with the overall reduction trend being highly similar to the diurnal model's inference performance. For instance, the range between 800 nm and 900 nm showed the highest variance reduction ratio of 60%. Conversely, when the diurnal calibration model had the least regression R², around 670 nm, the calibrated variance ratio only reached approximately 28%. FIG. 7B shows the comparison of the results from the above-mentioned nine wavelengths. In addition to significantly narrowing the range of all variance bars, the relative reflectance values were shifted to different locations via diurnal calibration. This phenomenon may be attributed to the relationship between the reflectance at solar noon and other times of the day. Moreover, it was observed that the number of outliers at several wavelengths decreased compared to the number of outliers in the original data. The diurnal calibration model was found to significantly reduce the noise introduced by imaging time, as demonstrated by the variance reduction observed in the analysis. This highlighted the model's effectiveness in improving the quality of hyperspectral data in remote sensing applications.

Those having ordinary skill in the art will recognize that numerous modifications can be made to the specific implementations described above. The implementations should not be limited to the particular limitations described. Other implementations may be possible.

1. A method of calibrating hyperspectral images from a field of one or more plants to account for diurnal changes at different times, comprising:
receiving a plurality of hyperspectral images over a plurality of days from a field having planted thereon one or more plants;
deriving a plurality of spectra from the received plurality of hyperspectral images;
decomposing the derived plurality of spectra into a trend component representing a trend associated with the plurality of days;
subtracting the trend component from the derived plurality of spectra to thereby generate diurnal spectra for one or more wavelengths;
fitting one or more mathematical functions associating spectrum to time of day to the generated diurnal spectra for each of the one or more wavelengths;
generating a model from the fitted mathematical functions for each of the one or more wavelengths; and
applying the model to the derived spectra at a first time to generate a calibrated spectra at a second time.

2. The method of claim 1, wherein the one or more mathematical functions includes a polynomial.

3. The method of claim 1, wherein the generated model is a transformational matrix representing the one or more mathematical functions.

4. The method of claim 1, wherein the generated model is a 3-dimensional graph representing the one or more mathematical functions.

5. The method of claim 1, wherein the one or more plants includes one or more of corn, wheat, or soybean.

6. The method of claim 1, wherein the plurality of spectra are derived based on pre-processing the received plurality of hyperspectral images by applying a reference calibration to account for variations in illumination conditions and atmospheric effects affecting spectral signatures of the one or more plants.

7. The method of claim 6, wherein the pre-processing further includes segmenting a region of interest (ROI) based on a distinction between background field and foreground plants followed by an averaging function to generate an average spectrum of an entire plant region.

8. The method of claim 7, wherein the segmentation includes obtaining Normalized Difference Vegetation Index (NDVI) to establish a heatmap and a threshold for segmentation.

9. The method of claim 7, wherein the pre-processing further includes discrete wavelet transformation, Savitzky-Golay smoothing, and moving average smoothing transforming resolution of spectral features into multilevel components, representing both high- and low-frequency information, and provide an averaging thereof.

10. The method of claim 9, wherein the pre-processing further includes partial spectral removal to thereby remove several wavelengths from beginning and end of the spectra having a plurality of wavelengths to mitigate impact of noise and spectra artifacts brought about by the instrumentation to give rise to the one or more wavelengths.

11. The method of claim 10, wherein the pre-processing further includes a spectra quality control based on an interquartile range from a single wavelength to generate the plurality of spectra at variant times by removing datapoints outside of the interquartile range.

12. A method of generating a model based on received hyperspectral images from a field of one or more plants to account for diurnal changes at different times, comprising:
receiving a plurality of hyperspectral images over a plurality of days from a field having planted thereon one or more plants;
deriving a plurality of spectra from the received plurality of hyperspectral images;
decomposing the derived plurality of spectra into a trend component representing a trend associated with the plurality of days;
subtracting the trend component from the derived plurality of spectra to thereby generate diurnal spectra for one or more wavelengths;
fitting one or more mathematical functions associating spectrum to time of day to the generated diurnal spectra for each of the one or more wavelengths; and
generating a model from the fitted mathematical functions for each of the one or more wavelengths.

13. The method of claim 12, wherein the one or more mathematical functions includes a polynomial.

14. The method of claim 12, wherein the generated model is a transformational matrix representing the one or more mathematical functions.

15. The method of claim 12, wherein the generated model is a 3-dimensional graph representing the one or more mathematical functions.

16. The method of claim 12, wherein the one or more plants includes one or more of corn, wheat, or soybean.

17. The method of claim 12, wherein the plurality of spectra are derived based on pre-processing the received plurality of hyperspectral images by applying a reference calibration to account for variations in illumination conditions and atmospheric effects affecting spectral signatures of the one or more plants.

18. The method of claim 17, wherein the pre-processing further includes segmenting a region of interest (ROI) based on a distinction between background field and foreground plants followed by an averaging function to generate an average spectrum of entire plant region.

19. The method of claim 18, wherein the segmentation includes obtaining Normalized Difference Vegetation Index (NDVI) to establish a heatmap and a threshold for segmentation.

20. The method of claim 19, wherein the pre-processing further includes discrete wavelet transformation, Savitzky-Golay smoothing, and moving average smoothing transforming resolution of spectral features into multilevel components, representing both high- and low-frequency information, and provide an averaging thereof.

21. The method of claim 20, wherein the pre-processing further includes partial spectral removal to thereby remove several wavelengths from beginning and end of the spectra having a plurality of wavelengths to mitigate impact of noise and spectra artifacts brought about by the instrumentation to give rise to the one or more wavelengths.

22. The method of claim 21, wherein the pre-processing further includes a spectra quality control based on an interquartile range from a single wavelength to generate the plurality of spectra at variant times by removing datapoints outside of the interquartile range.

23. A method of applying a model based on received hyperspectral images from a field of one or more plants to account for diurnal changes at different times, comprising:
establishing a plurality of spectra based on a plurality of captured hyperspectral images over a plurality of days from a field having planted thereon one or more plants;
receiving a model associating spectrum to time of day for one or more wavelengths, wherein the received model takes into account diurnal changes at different times; and
applying the model to the established plurality of spectra at a first time to generate a calibrated spectra at a second time.

24. The method of claim 23, wherein the received model is a transformational matrix representing one or more mathematical functions.

25. The method of claim 23, wherein the received model is a 3-dimensional graph representing one or more mathematical functions.

26. The method of claim 23, wherein the one or more plants includes one or more of corn, wheat, or soybean.

27. The method of claim 23, wherein the received plurality of spectra are derived based on pre-processing the plurality of hyperspectral images by applying a reference calibration to account for variations in illumination conditions and atmospheric effects affecting spectral signatures of the one or more plants.

28. The method of claim 27, wherein the pre-processing further includes segmenting a region of interest (ROI) based on a distinction between background field and foreground plants followed by an averaging function to generate an average spectrum of entire plant region.

29. The method of claim 28, wherein the segmentation includes obtaining Normalized Difference Vegetation Index (NDVI) to establish a heatmap and a threshold for segmentation.

30. The method of claim 29, wherein the pre-processing further includes discrete wavelet transformation, Savitzky-Golay smoothing, and moving average smoothing transforming resolution of spectral features into multilevel components, representing both high- and low-frequency information, and provide an averaging thereof.

31. The method of claim 30, wherein the pre-processing further includes partial spectral removal to thereby remove several wavelengths from beginning and end of the spectra having a plurality of wavelengths to mitigate impact of noise and spectra artifacts brought about by the instrumentation to give rise to the one or more wavelengths.

32. The method of claim 31, wherein the pre-processing further includes a spectra quality control based on an interquartile range from a single wavelength to generate the plurality of spectra at variant times by removing datapoints outside of the interquartile range.
